(19) United States
(12) Patent Application Publication
(10) Pub. No.: US 2009/0150279 A1
(43) Pub. Date: Jun. 11, 2009

(54) DEVICE, SYSTEM, AND METHOD OF ONLINE TRADING

(76) Inventor: Gad Hadar, St Kilda (AU)

Correspondence Address: EMPK & Shiloh, LLP;c/o Landon IP, Inc., 1700 Diagonal Road, Suite 450, Alexandria, VA, 22314, US

(21) Appl. No.: 12/331,535

(22) Filed: Dec. 10, 2008

Related U.S. Application Data
(60) Provisional application No. 61/012,470, filed on Dec. 10, 2007.

(51) Int. Cl. G06Q 40/00

(52) U.S. Cl. 705/37

(57) ABSTRACT

In some embodiments, a system may include a memory having stored thereon trading-application instructions; and a processor to execute the trading-application instructions resulting in a trading application, wherein the trading application is able to cause a display device to display to a user a visualized trading tool corresponding to a trade position of the user with relation to a financial instrument, wherein the visualized trading tool includes at least one graphical element representing the trade position, and one or more user-controllable graphical indicators representing one or more respective position-related parameters of the trade position, and wherein the trading application is able to receive an input responsive to movement of at least one of the graphical indicators and to dynamically update the trade position based on the input. Other embodiments are described and claimed.

### CROSS-REFERENCE

This application claims priority from and the benefit of U.S. Provisional Patent application 61/012,470, entitled “Device, System and Method of Online Trading”, filed Dec. 10, 2007, the entire disclosure of which is incorporated herein by reference.

### FIELD

Some embodiments relate to the field of online trading.

### BACKGROUND

A computing system may be used to allow multiple users to trade stocks, bonds, mutual funds, Foreign Exchange (ForEx), or other instruments or commodities. For example, users utilize computing devices to submit “buy” orders and “sell” orders to a host computer, which matches between orders and electronically facilitates transactions among the users.

As the sophistication of trading platforms grows, current trading systems are often cumbersome and not sufficiently user-friendly to the point of compromising the efficiency at which transactions are performed. For example, it may be difficult for many users to efficiently read and/or correctly analyze the extensive volume of financial data which may be obtained from the electronic trading system, within the short time frame available to perform transactions in today's fast and dynamic markets.

### SUMMARY

Some embodiments include, for example, devices, systems, and methods of online trading, and applications and/or tools for use in conjunction with online trading platforms.

In some embodiments, a system may include a memory having stored thereon trading-application instructions; and a processor to execute the trading-application instructions resulting in a trading application. The trading application is able to cause a display device to display to a user a visualized trading tool corresponding to a trade position of the user with relation to a financial instrument. The visualized trading tool includes at least one graphical element representing the trade position, and one or more user-controllable graphical indicators representing one or more respective position-related parameters of the trade position. The trading application is able to receive an input responsive to movement of at least one of the graphical indicators and to dynamically update the trade position based on the input.

In some embodiments, the trading application is able to dynamically update the trade position by updating the trade-position-related parameters based on the input.

In some embodiments, the trading application is able to provide an indication of the one or more updated trade-position-related parameters to a transaction-processing system.

In some embodiments, the trading application is able to provide the user with at least one of a profit limit and a loss limit corresponding to the trade position, and to update the at least one of the profit and loss limits based on the movement of the graphical indicator by the user.

In some embodiments, the one or more position-related parameters include at least one of a stop-loss value and a take-profit value.

In some embodiments, the trading application is able to dynamically update the graphical element based on real-time data corresponding to one or more instrument-related parameters corresponding to the financial instrument.

In some embodiments, the instrument-related parameters include at least one of an open rate and a current rate of the financial asset.

In some embodiments, the one or more user-controllable graphical indicators include a stop-loss indicator indicating a stop-loss value defined by the user and a take-profit indicator indicating a take-profit value defined by the user. The graphical element may include a graphical representation of a current value of the financial asset positioned between the stop-loss and take-profit indicators.

In some embodiments, the graphical element is a two-or-more dimensional graphical element.

In some embodiments, the financial asset includes a foreign-exchange asset corresponding to at least a pair of currencies.

In some embodiments, the at least one graphical element includes at least one of a gear, a semi-circular gear, a bar chart, and a belt chart.

In some embodiments, a system may include a memory having stored thereon trading-application instructions; and a processor to execute the trading-application instructions resulting in a trading application, wherein the trading application is able to receive a user input requesting aggregated trade-position data corresponding to at least one financial asset. The trading application is able to receive from a database trade-position data of a plurality of trade positions of a plurality of other users with relation to the financial asset. The trading application is able to determine the aggregated trade-position data based on the plurality of trade positions. The trading application is able to cause a display device to display to the user a visualized trading tool representing the aggregated trade-position data.

In some embodiments, the application is able to receive real-time trade-position data, to dynamically update the aggregated trade-position data based on the real-time trade-position data, and to dynamically update the visualized trading tool based on the updated aggregated trade-position data.

In some embodiments, at least one financial asset includes a plurality of financial assets. The visualized trading tool indicates one or more proportional relationship values corresponding to one or more of the plurality of financial assets. The application is able to determine a proportional relationship value of the one or more proportional relationship values corresponding to a financial asset of the plurality of financial assets based on a relationship between a volume-related value corresponding to the financial asset and volume-related values corresponding to other financial assets of the plurality of financial assets. The application is able to cause the display device to display to the user the visualized trading tool indicating the one or more proportional relationship values.

In some embodiments, the proportional relationship value corresponding to the financial asset includes at least one of: a ranking of the volume-related value corresponding to the financial asset relative to the volume-related values corresponding to the other financial assets, and a ratio between the volume-related value corresponding to the financial asset and a total of the volume-related values corresponding to the plurality of financial assets.

In some embodiments, the volume-related value corresponding to the financial asset includes a number of trade positions corresponding to the financial asset.

In some embodiments, the plurality of financial assets include a plurality of currency pairs.

In some embodiments, the visualized trading tool includes a pi-chart, which includes a plurality of segments corresponding to the proportional relationship values, respectively.

In some embodiments, the visualized trading tool corresponds to a pair of first and second currencies. The application is able to receive trade-position data corresponding to the first and second currencies. The application is able to determine a first number of trade-positions relating to selling the first currency and buying the second currency and a second number of trade-positions relating to selling the second currency and buying the first currency. The application is able to determine a proportional relationship between the first and second numbers. The application is able to cause the display device to display to the user visualized trading tool visualizing the proportional relationship between the first and second numbers.

In some embodiments, the visualized trading tool includes a visualized representation of a plurality of previous proportional relationships between the first and second numbers.

In some embodiments, the application is able to receive at least a plurality of stop-loss values of the plurality of trade-positions, respectively, and a plurality of take-profit values of the plurality of trade-positions, respectively. The application is able to determine an average stop-loss value based on the plurality of stop-loss values, and an average take-profit value based on the plurality of take-profit values. The application is able to cause the display device to display to the user the visualized trading tool visualizing a relationship between the average stop-loss value, the average take-profit value and a current value of the financial asset.

In some embodiments, the visualized trading tool includes a visualized representation of a plurality of previous values of the financial asset. The application is able to receive an input responsive to a user selected previous value of the financial asset. The application is able to update the visualized trading tool to visualize a relationship between previous average stop-loss and average take-profit values corresponding to the selected previous value of the financial asset.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a trading system in accordance with some demonstrative embodiments.

FIG. 2 is a schematic block diagram illustration of a visualization and trading tool able to dynamically generate visual representation of currency transactions popularity in accordance with a demonstrative embodiment.

FIG. 3 is a schematic block diagram illustration of a visualization and trading tool able to dynamically generate visual representation of a direction comparison between currency transactions of a currency pair in accordance with a demonstrative embodiment.

FIG. 4 is a schematic block diagram illustration of a visualization and trading tool able to dynamically generate visual representation of a structure belt of currency transactions of a currency pair in accordance with a demonstrative embodiment.

FIG. 5 is a schematic block diagram illustration of a visualization and trading tool able to dynamically generate visual representation of an open position bar in accordance with a demonstrative embodiment.

FIG. 6 is a schematic block diagram illustration of a visualization and trading tool able to generate a dynamic trading gear in accordance with a demonstrative embodiment.

FIGS. 7-40 are schematic illustrations of interface components and trading tools in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth ®, Global Positioning System (GPS), Wi-Fi, Wi-Max, ZigBee ™, Global System for Mobile communication (GSM), 2 G, 2.5 G, 3 G, 3.5 G, or the like. Some embodiments may be used in various other devices, systems and/or networks.

Some demonstrative embodiments are described herein in the context of Foreign Exchange (ForEx or FOREX) or currencies, e.g., a currency pair. It should be appreciated, however, that some embodiments may be applied to other financial instruments (FIs) and/or markets, for example, stocks, bonds, negotiable instruments, fungible items or assets, debentures, equity, debts, loans, mortgages, certificates, mutual funds, options, Contracts For Difference (CFDs), or the like. Some embodiments may be applied to other options and/or option-like financial instruments, e.g., options on interest rate futures, options on commodities, and/or options on non-asset instruments, such as options on the weather, and the like, with variation as may be necessary to adapt for factors unique to a given financial instrument.

Although portions of the discussion herein relate, for demonstrative purposes, to certain graphical elements or shapes, e.g., a pie chart, a bar chart, a semi-circular gear, or the like, some embodiments may be implemented using any suitable graphical elements having other shapes, dimensions, or characteristics; for example, using a semi-circular gear; a circular or oval gear; a “dashboard” shaped or “clock” shaped interface; a pie chart; a bar chart; a graphical element associated with movable indicators or components; graphical elements which may be moved, dragged or resized; a graph having edges or points which may be moved or dragged; or other shapes having re-sizeable perimeter, dimensions, or characteristics.

In some embodiments, a system may include one or more user stations or devices (“users”), for example, a PC, a laptop computer, a PDA device, a terminal, and/or any other suitable device, that allow one or more users to perform one or more trading operations, for example, open, define and/or modify (“structure”) a trade position, close a trade position, and/or buy and/or sell one or more financial instruments, e.g., as described herein.

The system may also include an interface to interface between the users and one or more trading systems and/or services. The interface may be associated with and/or included as part of the user devices. In one example, the interface may be implemented, for example, as middleware, as part of any suitable application, and/or as part of a server. The interface may be implemented using any suitable hardware components and/or software components, for example, processors, controllers, memory units, storage units, input units, output units, communication units, operating systems, applications. In some embodiments, the interface may include, or may be part of a Web-based structuring/pricing application, a web-site, a web-page, a stand-alone application, a plug-in, an ActiveX control, a rich content component (e.g., a Flash or Shockwave component), or the like.

In some embodiments, the interface may be implemented as part of the trading systems/services and/or as part of any other suitable system or module, e.g., as part of a server.

The user devices may be implemented using suitable hardware components and/or software components, for example, processors, controllers, memory units, storage units, input units, output units, communication units, operating systems, applications, or the like.

The one or more trading systems and/or services may provide any suitable trade-related services, e.g., to the users. The trade-related services may include, for example, one or more portfolio management systems, one or more pricing services, one or more analysis services, one or more structuring services, one or more trading systems, one or more exchange connectivity systems, one or more market data systems, one or more market news systems, and/or one or more other suitable trade-related services, systems and/or platforms.

The interface may include a user interface, allowing the users to interact with one or more of the trading systems and/or services, for example, to enter commands; to define a financial instrument; to define, open, close and/or structure a trade-position corresponding to the financial instrument; to analyze the trade-position; to execute the trade-position; to simulate the trade-position and/or to otherwise control and/or analyze the user's structuring/trading operations.

Some embodiments include a Foreign Exchange trading platform, which includes visual and/or dynamic tools to facilitate trading and/or to present trading-related information to a user. For example, dynamic visual tools and graphical elements may be used to dynamically present to the user current and/or historic data or statistical information, and/or to allow the user to create or open a trade-position (“position”), to modify a position, to close a position, and/or to simulate a position, as described herein.

In some embodiments, the trading platform may translate Foreign Exchange data into graphical or visual representations; and/or translates operations on graphical components, e.g., dragging, dropping, moving, re-sizing, or the like, into trading actions and/or into modification of trading parameters, as described herein.

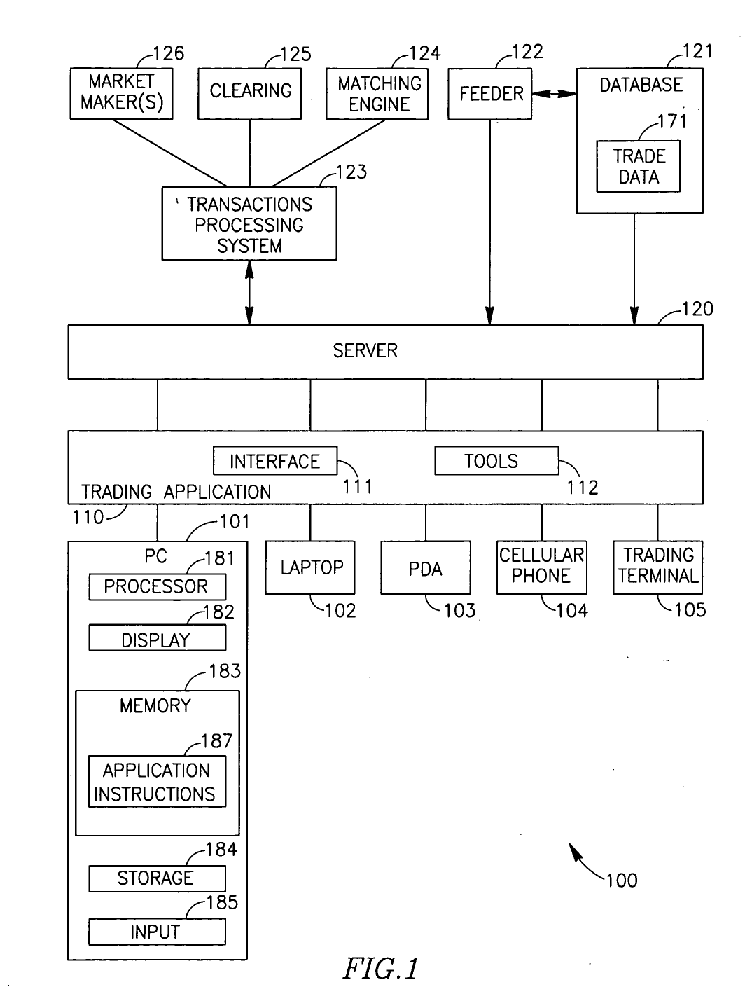

FIG. 1 schematically illustrates a block diagram of a trading system 100 in accordance with some demonstrative embodiments.

System 100 includes one or more stations or devices that allow users to trade Foreign Exchange, for example, a PC 101, a laptop computer 102, a PDA device 103, a cellular phone 104, a trading terminal 105 and/or any other suitable station or device, e.g., a desktop computer, a mobile computer, a notebook computer, a tablet computer, a handheld computer, a handheld device, an on-board device, an off-board device, a hybrid device, a vehicular device, a non-vehicular device, a mobile or portable device, a non-mobile or non-portable device, a wireless communication station, a wireless communication device, a Personal Communication Systems (PCS) device, a PDA device which incorporates a wireless communication device, a wired or wireless handheld device (e.g., BlackBerry, Palm Treo), a Wireless Application Protocol (WAP) device, or the like.

At least one of the stations may include, for example, a processor 181, a display device 182, a memory 183, a storage 184, an input unit 185 and/or any other suitable hardware and/or software components.

Processor 181 includes, for example, a multi-core processor (CMP), a multiprocessor, a central processing unit (CPU), a digital signal processor (DSP), a microprocessor, a host processor, a controller, a plurality of processors or controllers, a chip, a microchip, circuitry, a logic unit, an integrated circuit (IC), an application-specific IC (ASIC), or any other suitable multi-purpose or specific processor or controller.

Memory 183 includes, for example, a random access memory (RAM), a dynamic RAM (DRAM), a synchronous DRAM (SD-RAM), a non-volatile memory, a volatile memory, a memory buffer, a short-term memory, or other suitable memory unit.

Storage 184 includes, for example, a hard disk drive, a floppy disk drive, a compact disk (CD) drive, a CD-ROM drive, a digital versatile disk (DVD) drive, or other suitable removable or non-removable storage units.

Input unit 185 includes, for example, a keyboard, a keypad, a mouse, a touch-pad, a stylus, a microphone, or other suitable pointing device or input device.

Display device 182 includes, for example, a cathode ray tube (CRT) monitor or display unit, a liquid crystal display (LCD) monitor or display unit, a screen, a monitor, or other suitable display unit.

In some embodiments, devices 101, 102, 103 and/or 105 include, or are associated with, a trading and/or visualization application 110.

In some embodiments, application 110 may be implemented using a Web-based trading application, a web application, a web2 application, an Asynchronous JavaScript And XML (Ajax) application, a web-site, a web-page, a stand-alone application, a plug-in, an ActiveX control, a rich content component (e.g., a Flash or Shockwave component), or the like.

In some embodiments, application 110 may be implemented by any suitable computer program product. The computer program product may include, for example, a suitable computer-useable medium, which includes a computer-readable program, e.g., in the form of instructions. The computer-readable program, when executed by a processor, causes the processor to execute application 110.

In some embodiments, application 110 may include a “local” application executed by processor 181, for example, by executing trade-application instructions 187, which may be stored, for example, by memory 183 and/or storage 184. In one embodiment, trade-application instructions 187 may be downloaded and/or received from a remote location, for example, a remote server, e.g., a server 120 as is described below. For example, instructions 187 may be received and stored, e.g., temporarily, in memory 183 or any suitable short-term memory or buffer, e.g., prior to being executed by processor 181. In other embodiments, trade-application instructions 187 may be provided in any other suitable manner.

In some embodiments, trading application 110 includes an interface 111, allowing a user to enter commands, to place a “sell” order”, to place a “buy” order”, to retrieve quotes, to structure a trade-position, to retrieve data, or to otherwise control the user's trading operations. For example, the user may enter the commands to interface 111 using input 185.

In some embodiments, trading application 110 includes one or more tools 112, for example, one or more dynamic trading tools, visual trading tools, dynamic visualization tools, and/or other trading-related tools as described herein. In one embodiment, interface 111 includes an “inside view” panel having one or more tools 112. In other embodiments, one or more tools 112 may be implemented and/or presented in any other suitable format and/or as part of any suitable panel, menu and the like.

In some embodiments, devices 101, 102, 103, 104 and/or 105 communicate with server 120 using one or more wired links and/or wireless links, e.g., through any suitable wireless shared-access medium. For example, devices 101, 102, 103, 104 and/or 105 may submit orders to server 120, and retrieve information from server 120. Server 120 may be associated with a database 121, which stores data related to orders placed by the users. Server 120 and/or database 121 are optionally associated with a feeder 122, for example, a source which generates or streams real-time or non-real-time data, quotes, information about transactions made in the market, or the like.

In some embodiments, database 121 may store trade-position data 171 of a plurality of trade positions of the plurality of users of trading system 100 with relation to a plurality of financial assets. In one embodiment, database 121 may store trade-position data 171 of at least hundreds of users, for example, at least thousands of users, e.g., at least tens of thousands of users.

In some embodiments, trade-position data 171 may relate to a plurality of different financial assets. In one embodiment, trade-position data 171 may relate to a plurality of different currency pairs. For example, trade-position data 171 may include data of trade positions with respect to pairs of the currencies US dollar (USD), Japanese Yen (JPY), Great-Britain Pound (GBP), Euro (EUR), Swiss Frank (CHF), Australian Dollar (AUD), Canadian Dollar (CAD), Israeli Shekel (ILS), and the like. In another embodiment, trade-position data 171 may relate to one or more commodities. For example, trade-position data 171 may include data of trade positions with respect to the price of oil in USD (OIL/USD), and the like.

In some embodiments, trade-position data 171 may include data of currently open trade positions, closed trade positions, and/or historical trade positions and/or transactions.

In some embodiments, trade-position data 171 may include data of at least tens of thousands, for example, at least hundreds of thousands, e.g., at least one million, currently open, closed and/or historical trade positions and/or transactions.

In some embodiments, server 120 may be associated with a transactions processing system 123 able to process transactions, optionally using a matching engine 124, a clearinghouse 125, one or more market makers 126 and/or any other suitable module.

Devices 101, 102, 103 and/or 105, and/or server 120 may be implemented using any suitable hardware components and/or software components, for example, processors, controllers, memory units, storage units, input units, output units, communication units, operating systems, applications, or the like.

In some embodiments, trading application 110 may provide a visual representation, a graphical representation and/or an animated representation in response to a user's command. It will be appreciated that the terms “visual representation” and “graphical representation” as interchangeably used herein relate to any suitable illustration, animation, diagram, chart, graph, image, drawing, schema, and the like.

In some embodiments, the user of devices 101, 102, 103 and/or 105 may use input 185 and interface 111 to command trading application 110 to create, e.g., open, a new trading position. In response, trading application 110 may present a visual movement or displacement of data flow, from a first area, e.g., a ticket area in which the user inputs the data for opening the position, to a second area, e.g., an area designated to show the user's portfolio or open positions, as described herein. Trading application 110 may thus provide a visual representation and/or visual indication that a new position, e.g., a new transaction, was created by the user. Other suitable visualization tools may be used.

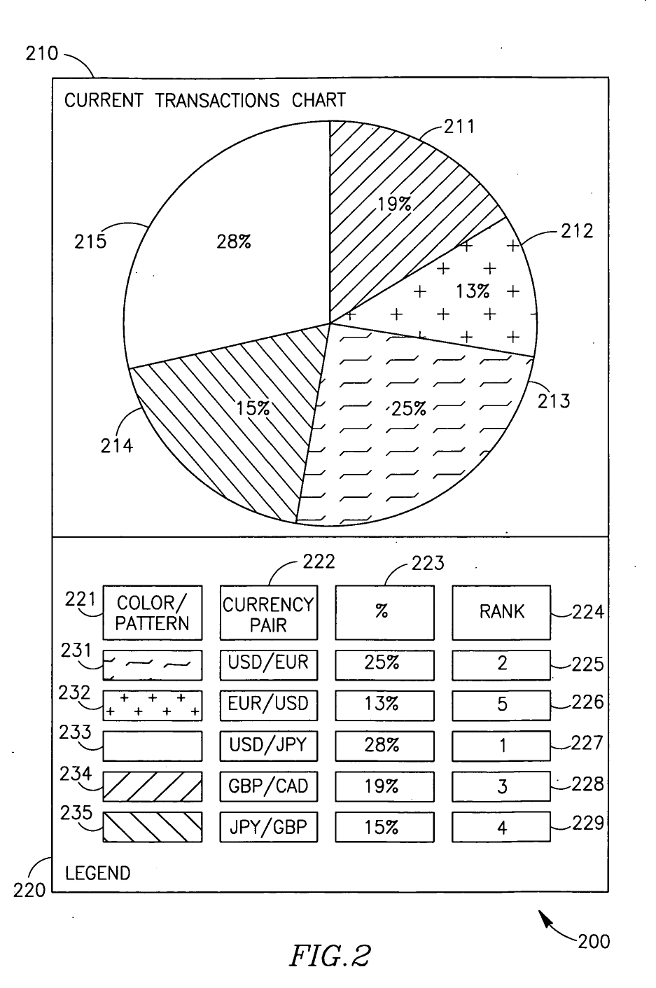

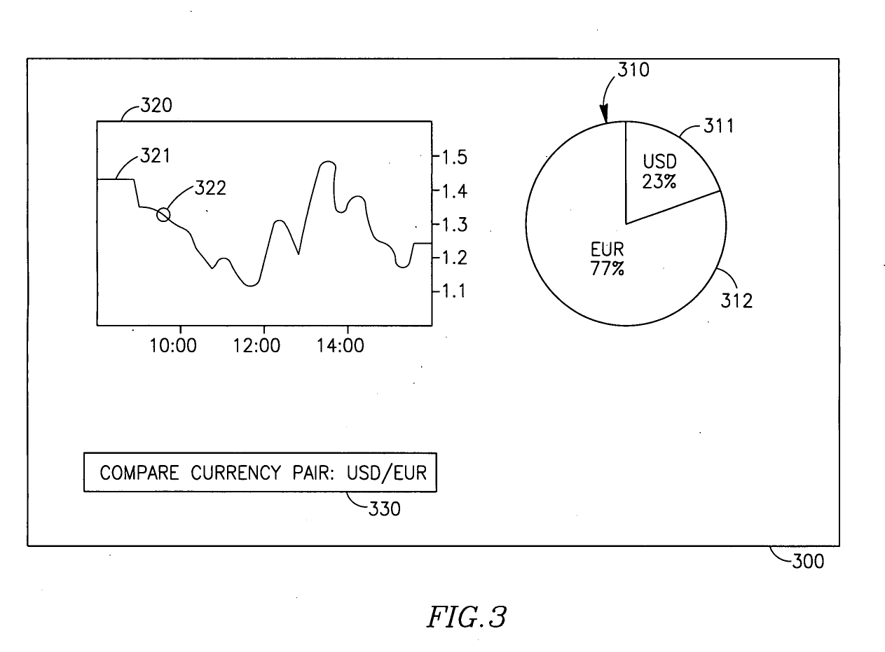

In some embodiments, trading application 110 may receive, e.g., via input 185 and/or interface 111, a user input responsive to a user request for aggregated trade-position data corresponding to at least one financial asset. For example, interface 111 may provide the user with the option to select an aggregated trade-position visualization tool, for example, from a set of predefined trade-position visualization tools, e.g., in the form of a menu or list. In one embodiment, tools 112 may include one or more predefined trade-position visualization tools, for example, as are described below with reference to FIGS. 2, 3 and/or 4.

In some embodiments, trading application 110 may receive, for example, from a database, e.g., database 121, trade-position data of a plurality of trade positions of a plurality of other users with relation to the financial asset, e.g., as described below. For example, application 110 may request from database 121 the trade position data, e.g., based on the aggregated trade-position visualization tool and/or at least one financial asset selected by the user.

In some embodiments, application 110 may determine the requested aggregated trade-position data based on the received data corresponding to the plurality of trade positions, e.g., as described below.

In some embodiments, application 110 may cause display 182 to display to the user a visualized trading tool 112 representing the aggregated trade-position data, e.g., as described below.

In some embodiments, application 110 may receive real-time trade-position data, e.g., from server 120, feeder 122 and/or any other suitable source. Application 110 may dynamically update the aggregated trade-position data based on the real-time trade-position data. Application 110 may also dynamically update the visualized trading tool 112 based on the updated aggregated trade-position data, e.g., as described below.

In some embodiments, tools 112 may include a “population” tool, e.g., as described below with reference to FIG. 2. For example, tool 112 may indicate one or more proportional relationship values corresponding to one or more of a plurality of financial assets.

In some embodiments, the plurality of financial assets includes, for example, a plurality of currency pairs. In other embodiments, the plurality of financial assets includes any other suitable financial assets.

In some embodiments, application 110 may determine a proportional relationship value of the one or more proportional relationship values corresponding to a financial asset of the plurality of financial assets based on a relationship between a volume-related value corresponding to the financial asset and volume-related values corresponding to other financial assets of the plurality of financial assets.

In some embodiments, the term “volume-related value” when used herein with relation to a financial asset, may include a value representing any suitable parameter corresponding to a trading volume of the financial asset, for example, a number of trade positions corresponding to the financial asset, the sizes and/or volumes of the trade positions corresponding to the financial asset, a combination, e.g., an weighted average of the number of trade positions and the sizes/volumes of the trade positions, and the like.

In one embodiment, application 110 may receive from database 121 a plurality of volume-related values of a plurality of trade-positions, e.g., all trade-positions, corresponding to a plurality of currency pairs, e.g., the numbers of the plurality of trade-positions corresponding to the plurality of currency pairs. For example, application 110 may receive from database 121 a plurality of volume-related values of a plurality of trade-positions, e.g., all trade-positions, corresponding to the currency pairs USD/EUR, EUR/USD, USD/JPY, JPY/USD, GBP/CAD, and the like.

In some embodiments, the proportional relationship value corresponding to the financial asset may include, for example, at least one of a ranking of the volume-related value corresponding to the financial asset relative to the volume-related values corresponding to the other financial assets, and a ratio between the volume-related value corresponding to the financial asset and a total of the volume-related values corresponding to the plurality of financial assets.

In some embodiments, application 110 may cause display device 182 to display to the user the visualized trading tool 112 indicating the one or more proportional relationship values. In one embodiment, the visualized trading tool 112 includes a pi-chart, which includes a plurality of segments corresponding to the proportional relationship values, respectively, e.g., as described below with reference to FIG. 2. In other embodiments, the visualized trading tool 112 includes any other suitable visual representation of the one or more proportional relationship values, e.g., in the form of a bar chart, a bar graph, and the like.

In some embodiments, tools 112 may include a “direction” tool corresponding to a pair of first and second currencies, e.g., as described below with reference to FIG. 3.

In some embodiments, application 110 may receive trade-position data corresponding to the first and second currencies, e.g., from database 112.

In some embodiments, application 110 may determine, e.g., based on the trade-position data received from database 112, a first number of trade-positions relating to selling the first currency and buying the second currency and a second number of trade-positions relating to selling the second currency and buying the first currency. Application 110 may determine a proportional relationship between the first and second numbers, e.g., as described below with reference to FIG. 3. For example, if the currency pair includes the pair of the USD and EUR, then application 110 may receive from database 121 a volume-related value of a plurality of trade-positions, e.g., all trade-positions, corresponding to the EUR/USD currency pair, e.g., the number of the plurality of trade-positions corresponding to the EUR/USD currency pair; and a volume-related value of a plurality of trade-positions, e.g., all trade-positions, corresponding to the USD/EUR currency pair, e.g., the number of the plurality of trade-positions corresponding to the USD/EUR currency pair.

In some embodiments, application 110 may cause display device 182 to display to the user visualized trading tool 112 visualizing the proportional relationship between the first and second numbers, e.g., as described below with reference to FIG. 3.

In some embodiments, application may receive real-time trade-position data corresponding to the currency pair, and dynamically update the visualized trading tool 112 to visualize the proportional relationship between the first and second numbers, e.g., in real-time.

In some embodiments, the visualized trading tool 112 may include a visualized representation of a plurality of previous proportional relationships between the first and second numbers, e.g., as described below with reference to FIG. 3. Application 110 may receive, e.g., via interface 11 and/or input 185, an input responsive to a previous value of the financial asset selected by the user. Application 110 may update the visualized trading tool 112 to visualize a relationship between previous average stop-loss and average take-profit values corresponding to the selected previous value of the financial asset, e/g., as described below with reference to FIG. 3.

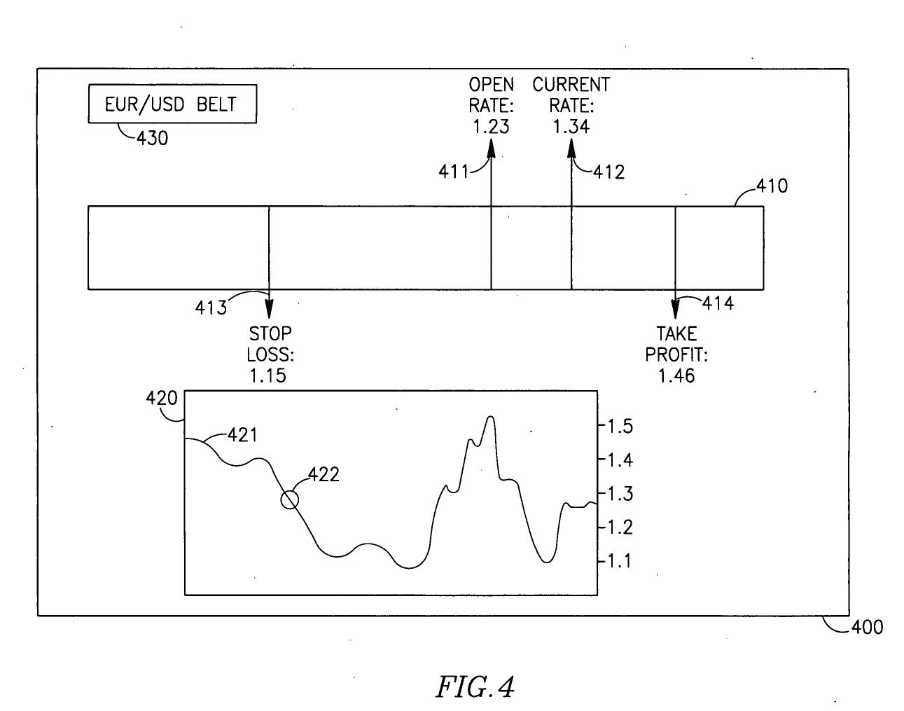

In some embodiments, tools 112 may include a “structure” tool corresponding to the financial asset, e.g., as described below with reference to FIG. 4.

In some embodiments, application 110 may receive, e.g., from database 121, at least a plurality of stop-loss values of the plurality of trade-positions corresponding to the financial asset, respectively, and a plurality of tale-profit values of the plurality of trade-positions, respectively. For example, if the financial asset includes the EUR/USD currency pair, then application 110 may receive from database 121 a plurality of stop-loss values and a plurality of take-profit values of a plurality of trade-positions, e.g., all trade-positions, corresponding to the EUR/USD currency pair.

In some embodiments, application 110 may determine an aggregated, e.g., an average, stop-loss value based on the plurality of stop-loss values, and an aggregated, e.g., average, take-profit value based on the plurality of take-profit values, e.g., as described below with reference to FIG. 4.

In some embodiments, application 110 may cause display device 182 to display to the user the visualized trading tool 112 visualizing a relationship between at least the aggregated stop-loss value, the aggregated take-profit value and a current value of the financial asset. Optionally, the visualized trading tool 112 may also visualize one or more other values, e.g., an open value of the financial asset, a historical value of the financial asset, and the like.

In some embodiments, the visualized trading tool 112 may include a visualized representation of a plurality of previous values of the financial asset, e.g., as described below with reference to FIG. 4. Application 110 may receive an input, e.g., via input 185 and/or interface 111, responsive to a user selected previous value of the financial asset. Application 11 may update the visualized trading tool 112 to visualize a relationship between previous aggregated stop-loss and aggregated take-profit values corresponding to the selected previous value of the financial asset, e.g., as described below with reference to FIG. 4.

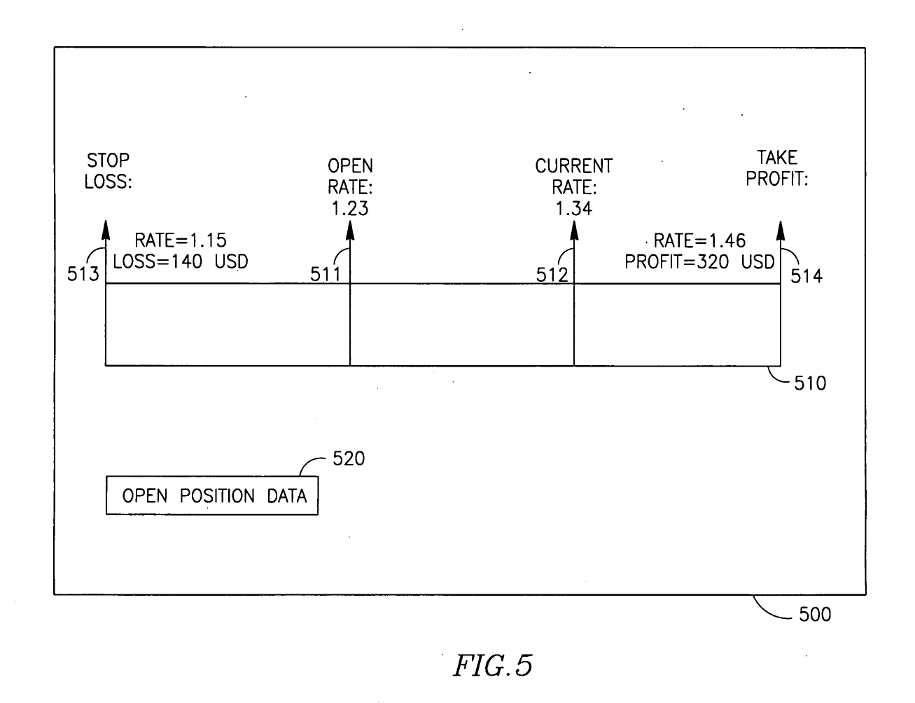

In some embodiments, trading application 110 may receive, e.g., via input 185 and/or interface 111, a user input responsive to a user request for using a visualized trading tool 112 corresponding to a trade position of the user with relation to a financial asset, e.g., as described below with reference to FIGS. 5 and/or 6. For example, interface 111 may provide the user with the option to use the visualized trading tool 112 with respect to a selected trading position, for example, from a set of currently opened trading positions of the user, e.g., in the form of a menu or list.

In some embodiments, the visualized trading tool 112 may include at least one graphical element representing the trade position, and one or more user-controllable graphical indicators representing one or more respective position-related parameters of the trade position, e.g., as described below.

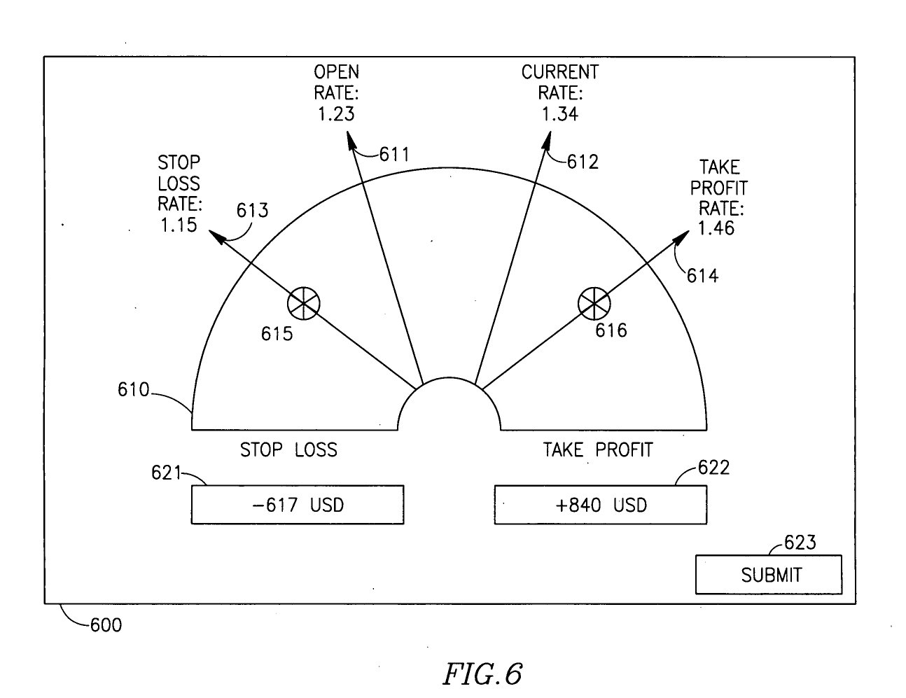

In one embodiment, the one or more position-related parameters include at least one of a stop-loss value and a take-profit value, e.g., as described below with reference to FIG. 6.

In one embodiment, the graphical element includes a two-or-more dimensional graphical element, e.g., a two- or more dimensional illustration, gear, belt, bar, semi-gear, graph, chart, and the like, e.g., as described below.

In one embodiment, the financial asset includes a foreign-exchange asset corresponding to at least a pair of currencies. In other embodiment, the financial asset includes any other suitable financial asset.

In some embodiments, trading application 110 may receive, e.g., via input 185 and/or interface 111, an input responsive to movement of at least one of the graphical indicators, e.g., by the user. Trading application 110 may dynamically update the trade position based on the input, e.g., as described below.

In some embodiments, trading application 110 may dynamically update the trade position by updating the trade-position-related parameters based on the input. In one embodiment, trading application 110 may provide an indication of the one or more updated trade-position-related parameters to transaction-processing system 123. For example, trading application 110 may send and/or transfer to transaction-processing system 123 one or more instructions and/or messages including and/or representing the updated trade-position-related parameters, and/or instructing transaction-processing system 123 to perform one or more operations, e.g., sell and/or buy operations, with relation to the trade position of the user, e.g., based on the updated trade-position-related parameters.

In some embodiments, trading application 110 may provide the user with at least one of a profit limit and a loss limit corresponding to the trade position, and to update the at least one of the profit and loss limits based on the movement of the graphical indicator by the user, e.g., as described below with reference to FIG. 6.

In some embodiments, trading application 110 may dynamically update the graphical element based on real-time data corresponding to one or more instrument-related parameters corresponding to the financial instrument. The instrument-related parameters may include at least one of an open rate and a current rate of the financial asset and/or any other suitable data. For example, trading application 110 may receive the real-time open rate and/or current rate of the financial asset, e.g., from server 120, feeder 122 and/or any other suitable source. Application 110 may dynamically update the graphical element based on the real-time open rate and/or current rate.

In some embodiments, the one or more user-controllable graphical indicators include a stop-loss indicator indicating a stop-loss value defined by the user and a take-profit indicator indicating a take-profit value defined by the user. Accordingly, the graphical element may include a graphical representation of a current value of the financial asset positioned between the stop-loss and take-profit indicators, e.g., as described below with reference to FIG. 6.

FIG. 2 schematically illustrates a block diagram of a visualization and trading tool 200 (e.g., a “popularity tool”) able to dynamically generate visual representation of currency trade-position popularity in accordance with some demonstrative embodiments. In one embodiment, tool 200 may perform the functionality of one of tools 112 (FIG. 1).

In some embodiments, too 200 may indicate one or more proportional relationship values corresponding to one or more of a plurality of financial assets. In the embodiments of FIG. 2, the plurality of financial assets includes, for example, a plurality of currency pairs. In other embodiments, the plurality of financial assets includes any other suitable financial assets.

In some embodiments, tool 200 includes a current transactions chart 210, e.g., in the form of a “pie” chart, and a legend 220. The current transactions chart 210 provides a graphical representation indicating the relative percentage of types of currency pair transactions, for example, using colors or patterns as described in the legend 220.

For example, a pie slice 211 may be displayed with a first color or pattern, and may include an indication of “19%”, namely, the relative percentage of currency transactions represented by the category of pie slice 211. The first color or pattern appears in row 234 of the legend 220, indicating that pie slice 211 corresponds to row 234 of the legend 220. As indicated in row 234, pie slice 211 represents a “GBP/CAD” currency-pair, which amounts to 19% of all the currency-pair transactions that are currently active in the trading system, e.g., in system 100 (FIG. 1). For example, application 110 (FIG. 1) may receive from database 121 (FIG. 1) trade position data relating to a plurality of trade-positions, e.g., all trade-positions, corresponding to a plurality of currency pairs, e.g., all currency pairs currently traded. Application 110 (FIG. 1) may calculate the number of GBP/CAD transactions, may calculate the total number of currency-pair transactions, and may then divide the number of GBP/CAD transactions by the total number of currency-pair transactions, thereby generating the relative percentage value which may be represented in pie slice 211.

Similarly, a pie slice 212 is displayed with a second color or pattern, and includes therein an indication of “13%”, namely, the relative percentage of currency transactions represented by the category of pie slice 212. The second color or pattern appears in row 232 of the legend 220, indicating that pie slice 212 corresponds to row 232 of the legend 220. As indicated in row 232, pie slice 212 represents a “EUR/USD” currency-pair, which amounts to 13% of all the currency pair transactions that are currently active in the trading system. For example, application 110 (FIG. 1) may calculate the number of EUR/USD transactions, and may then divide the number of EUR/USD transactions by the total number of currency-pair transactions, thereby generating the relative percentage value, which may be represented in pie slice 212.

Similarly, pie slice 213 corresponds to row 231 of the legend 220; pie slice 214 corresponds to row 235 of the legend 220; and pie slice 215 corresponds to row 233 of the legend 220.

The legend 220 may be dynamically sorted or filtered, for example, in response to a user's command. For example, selection of a color/pattern title 221 may sort the rows of legend 220 based on colors/patterns; selection of a currency pair title 222 may sort the rows of legend 220 based on currency pairs, e.g., in alphabetical order or reverse-alphabetical order; and selection of a percentage title 223 may sort the rows of legend 220 based on percentage value, e.g., increasing or decreasing.

In some embodiments, the popularity tool may visualize the relative percentage of the currency pair transactions, e.g., as described above. In some embodiments, the popularity tool may additionally or alternatively visualize one or more other proportional relationship values, e.g., relative ranking of the currency pair transactions.

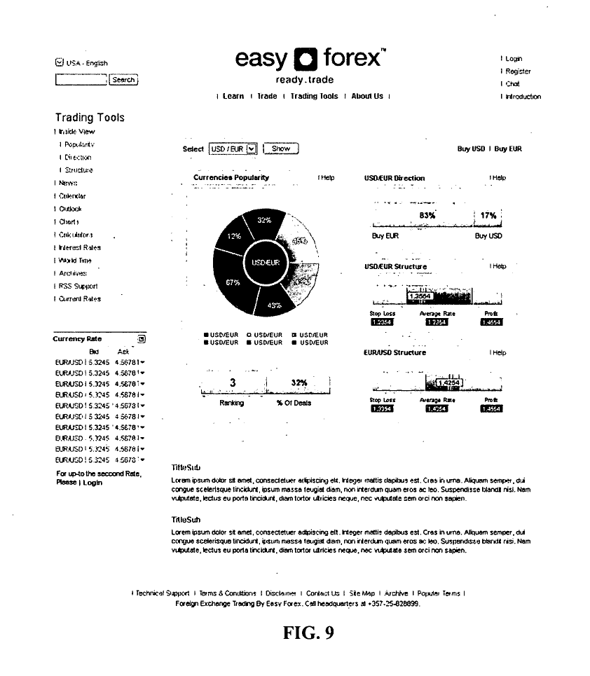

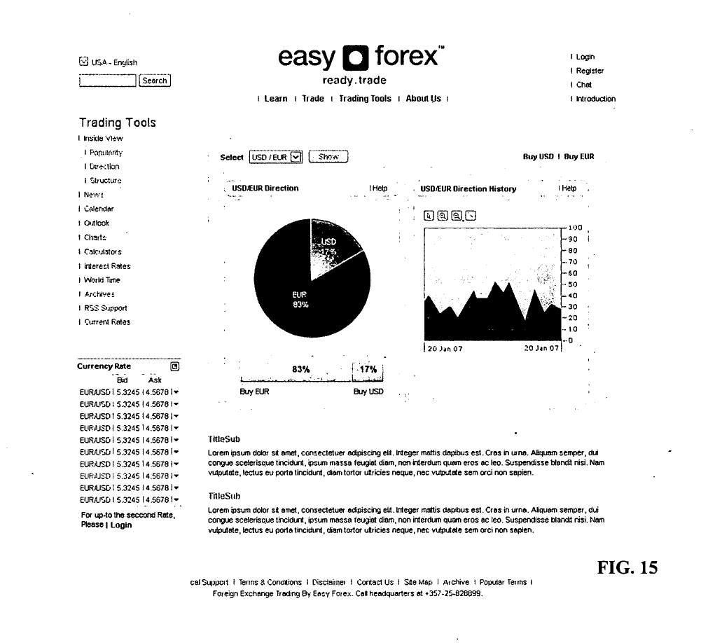

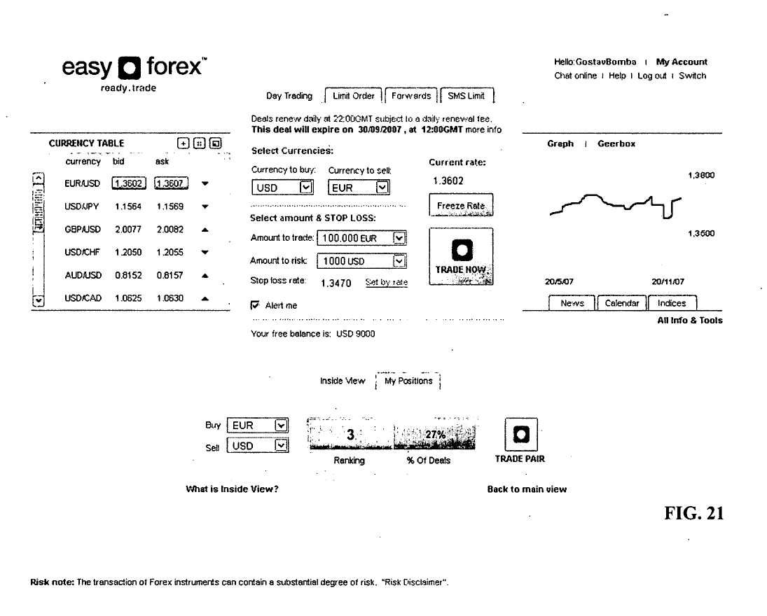

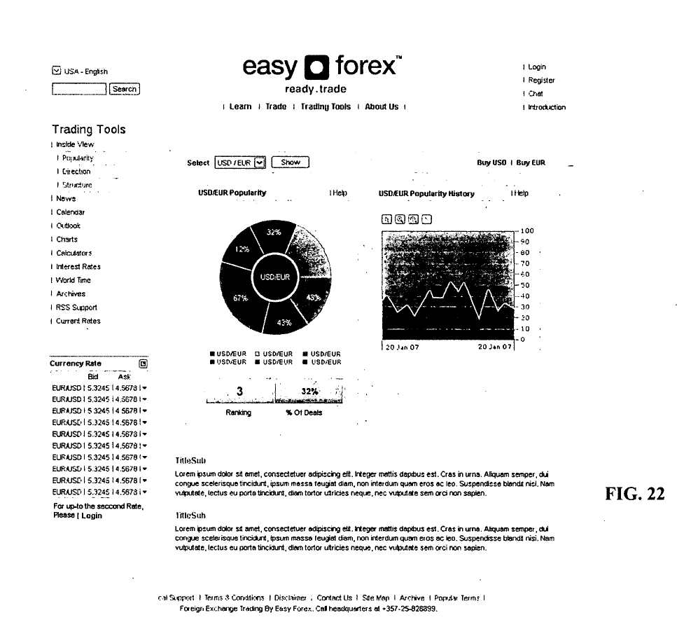

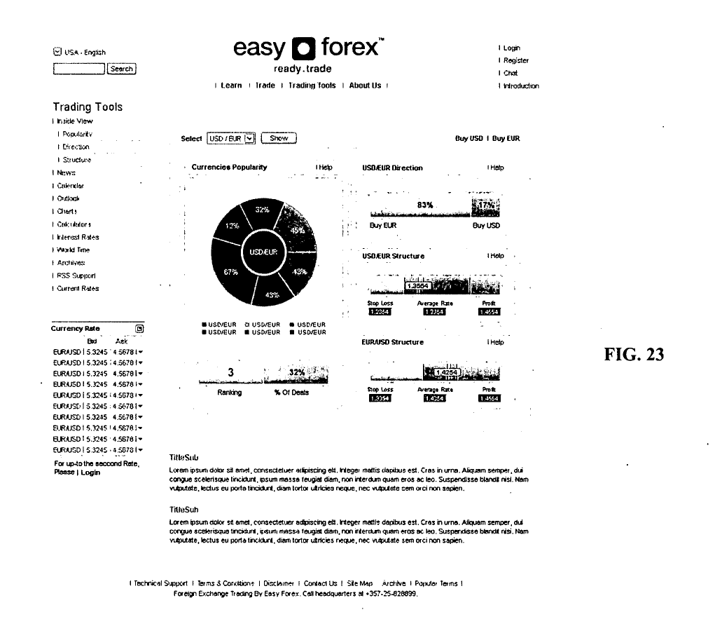

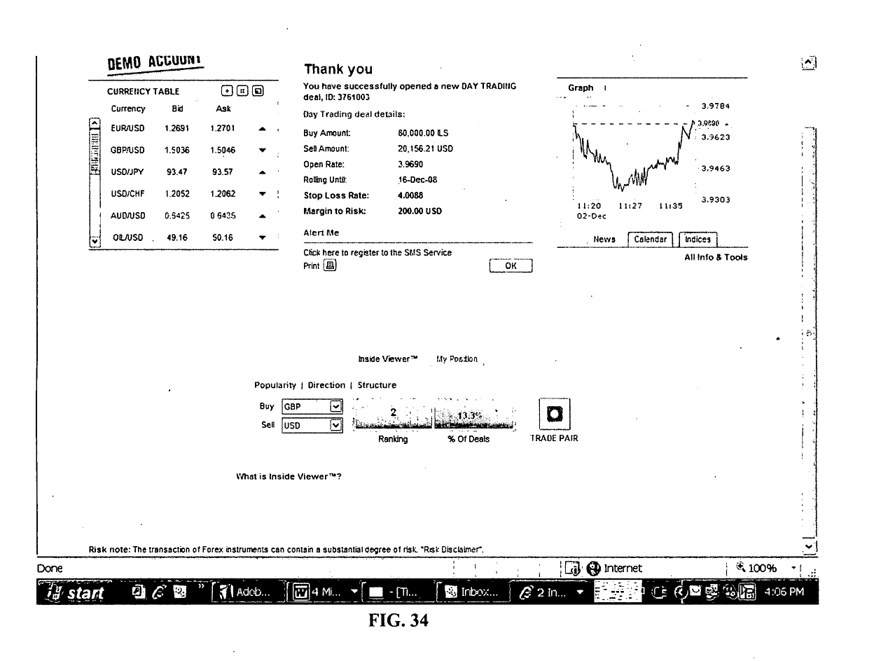

Although in some embodiments, e.g., as shown in FIG. 2, the popularity tool may include a transactions chart, e.g., chart 210, and a legend, e.g., legend 220, in other embodiments the popularity tool may include any other suitable visualization of the proportional relationship values, e.g., in the form of a bar chart, a belt chart, and/or any other suitable illustration and/or animation, e.g., the “ranking” illustrations shown in FIGS. 9, 13, 15, 21, 22, 23, 34, and/or 35.

In some embodiments, toll 200 may additionally or alternatively include an indication of a relative ranking of a volume-related value corresponding to a currency pair relative to the volume-related values corresponding to the other currency pairs. For example, toll 200 may include a rank indicator 224 indicating a relative ranking of the volume-related value corresponding to a certain currency pair relative to volume-related values corresponding to the other currency pairs. For example, an indicator 225 may indicate that the currency pair USD/EUR is ranked second relative to the other currency pairs; an indicator 226 may indicate that the currency pair EUR/USD is ranked fifth relative to the other currency pairs; an indicator 227 may indicate that the currency pair USD/JPY is ranked first relative to the other currency pairs; an indicator 228 may indicate that the currency pair GBP/CAD is ranked third relative to the other currency pairs; and/or an indicator 229 may indicate that the currency pair JPY/GBP is ranked fourth relative to the other currency pairs.

In some embodiments, tool 200 may optionally include other interface components, for example, buttons allowing the user to purchase various types of currencies, or buttons allowing the user to initiate various types of currency transactions.

In some embodiment, tool 200 may present a dynamic, real-time snapshot of the statistical distribution of currency transactions among substantially all the users of trading system 100 (FIG. 1). For example, tool 200 indicates that currently, 25 percent of currency transactions are transactions in which USD is bought and EUR is sold, and that 13 percent of currency transactions are transactions in which EUR is bought and USD is sold.

In some embodiments, application tool 100 (FIG. 1) may calculate the percentage based on the number of currency transactions. In other embodiments, application tool 100 (FIG. 1) may calculate the percentage is calculated based on any other suitable volume-related value, e.g., the volume of the currency transactions. In some embodiments, application 100 (FIG. 1) and/or tool 200 may calculate and/or display internal proportions of “long” and “short” transactions, for example, per currency pair. In other embodiments, other formulas may be used.

The data presented by tool 200 may be updated, re-calculated and/or refreshed, e.g., by application 110 (FIG. 1), for example, substantially continuously, substantially in real time, periodically, at pre-defined time intervals (e.g., every 15 seconds), in response to a user's command to refresh, and/or in response to incoming data indicating a change or a possible change in the presented data.

FIG. 3 schematically illustrates a block diagram of a visualization and trading tool 300 (e.g., a “direction tool”) able to dynamically generate visual representation of a comparison between currency transactions of a specific currency pair in accordance with some demonstrative embodiments. In one embodiment, tool 300 may perform the functionality of one of tools 112 (FIG. 1).

In some embodiments, application 110 (FIG. 1) may determine, e.g., based on the data received from database 112 (FIG. 1), a first number of trade-positions relating to selling a first currency and buying a second currency and a second number of trade-positions relating to selling the second currency and buying the first currency; and tool 300 may visualize a relationship between the first and second numbers.

In some embodiments, tool 300 may display a pie chart 310 showing a direction comparison between buy/sell and sell/buy transactions of the specific currency pair. For example, tag 330 indicates the currency pair under comparison, e.g., USD/EUR. Slice 311 of pie chart 310 shows 23 percent for USD and 77 percent for EUR. This represents that, out of the total USD/EUR and EUR/USD transactions currently active, 23 percent of the transactions request to buy USD and sell EUR, whereas 77 percent of the transactions request to buy EUR and sell USD.

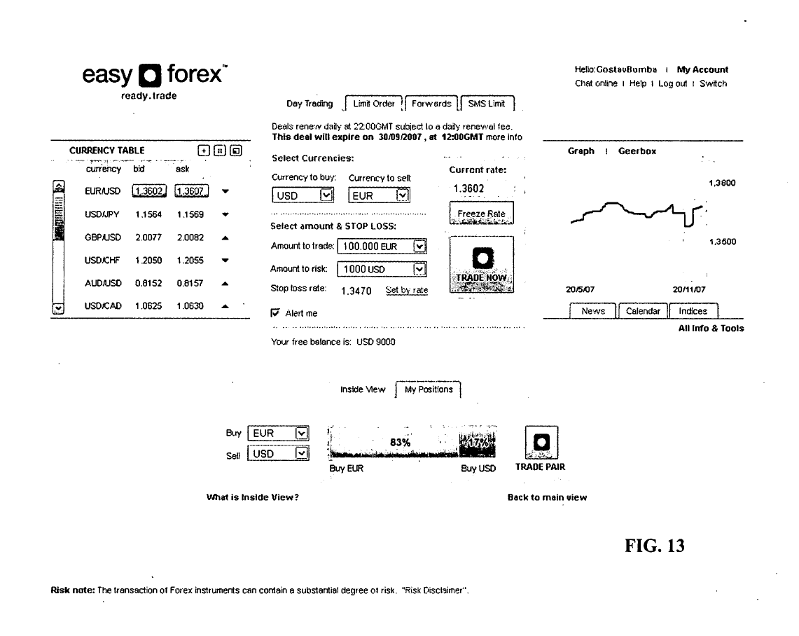

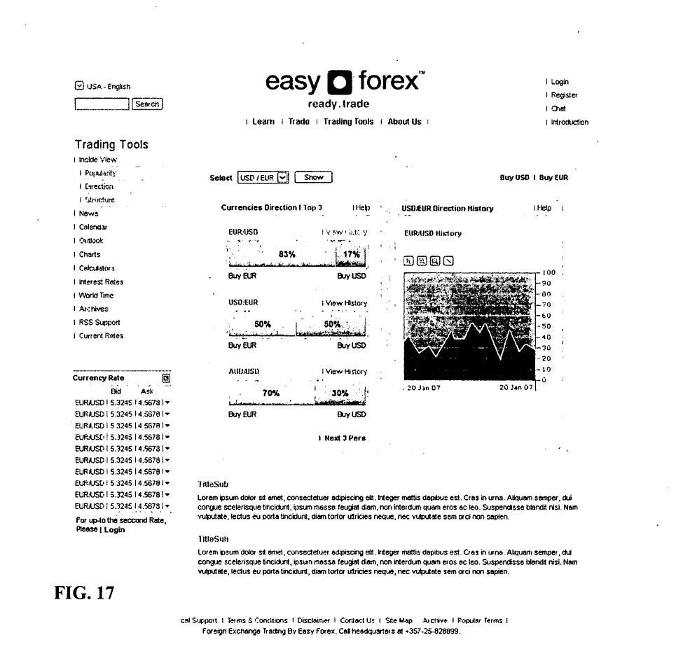

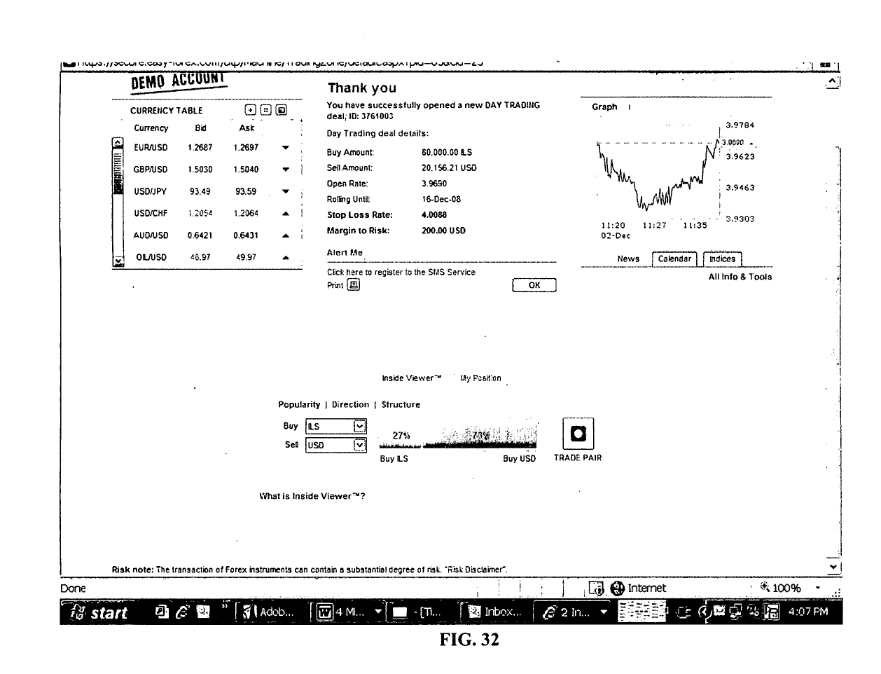

Although in some embodiments, e.g., as shown in FIG. 3, the direction tool may include a pi chart, e.g., chart 310, in other embodiments the direction tool may include any other suitable visualization, e.g., in the form of a bar chart, a belt chart, and/or any other suitable illustration and/or animation, e.g., the “direction” illustrations shown in FIGS. 13, 15, 17, 32, and/or 36.

A chart 320 shows a representation of historical comparisons between the two currencies of the relevant currency pair. For example, a horizontal axis of chart 320 indicates time, e.g., in hours, days, months, or years, whereas a vertical axis indicates the percentage of USD/EUR transactions out of all the USD/EUR and EUR/USD transactions active at that time. A graph 321 indicates the percentage values that correspond to a historical time period. A user-movable pointer 322 is utilized to dynamically select a point in time, and the pie chart 310 is updated or refreshed to reflect the historical comparison at the selected time in the past.

For example, as indicated by graph 321 of chart 320, at the time of approximately 09:00, the USD/EUR transactions were approximately 14 percent of the total USD/EUR and EUR/USD transactions, whereas at the time of approximately 11:00, the USD/EUR transactions were approximately 11 percent of the total USD/EUR and EUR/USD transactions.

In some embodiments, tool 300 analyzes substantially all the trading transactions of a specific currencies pair (for example, the USD/EUR pair). The results are shown using a current view reflecting current data, and/or using a historical view reflecting past data. Optionally, tool 300 may calculate and/or display the percentage of the currency pair transactions out of the total transactions, and/or the percentage of “long” transactions out of the total transactions of the currency pair. In some embodiments, percentage calculation may be based on number of transactions, and/or on volume of transactions.

The data presented by tool 300 may be updated, re-calculated and/or refreshed, e.g., by application 110 (FIG. 1), for example, substantially continuously, substantially in real time, periodically, at pre-defined time intervals (e.g., every 15 seconds), in response to a user's command to refresh, and/or in response to incoming data indicating a change or a possible change in the presented data.

The output generated by tool 300 may be related, or associated with, the output generated by tool 200 of FIG. 2, or vice versa. For example, the user may utilize tool 200 of FIG. 2 to see that 25 percent of all the transactions are USD/EUR transactions; selection of this currency pair in tool 200 may transfer the user to tool 300, which shows the internal comparison between USD/EUR and EUR/USD.

FIG. 4 schematically illustrates a block diagram of a visualization and trading tool 400 (e.g., a “structure tool”) able to dynamically generate visual representation of a structure belt of currency transactions of a currency pair in accordance with some demonstrative embodiments. In one embodiment, tool 400 may perform the functionality of one of tools 112 (FIG. 1).

In some embodiments, application 110 (FIG. 1) may receive, e.g., from database 121, at least a plurality of stop-loss values of the plurality of trade-positions corresponding to the financial asset, respectively, and a plurality of take-profit values of the plurality of trade-positions, respectively. For example, if the financial asset includes the EUR/USD currency pair, then application 110 may receive from database 121 a plurality of stop-loss values and a plurality of take-profit values of a plurality of trade-positions, e.g., all trade-positions, corresponding to the EUR/USD currency pair.

In some embodiments, application 110 (FIG. 1) may determine an aggregated, e.g., an average, stop-loss value based on the plurality of stop-loss values, and an aggregated, e.g., average, take-profit value based on the plurality of take-profit values; and cause display device 182 (FIG. 1) to display tool 400 to the user.

Tool 400 includes a tag 430 indicating the currency pair (for example, EUR/USD) for which a “belt” representation is generated. A belt 410 organizes four data items in their relevant order: an open rate indicator 411, indicating the exchange rate at the opening of the trade on the current day; a current rate indicator 412, indicating the current (or last) exchange rate or “quote”; a stop loss indicator 413, indicating the average maximum loss exchange rate (in which the system is required to sell the currency and close the position); and a take profit indicator 414, indicating an average maximum exchange rate (in which the system is required to sell the currency and close the position).

Optionally, the area between the stop loss indicator 413 and the open rate indicator 411 is shown in a first color and/or pattern, e.g., red, to indicate a loss area; whereas the area between the open rate indicator 411 and the take profit indicator 414 is shown in a second color and/or pattern, e.g., green, to indicate a profit area.

A chart 420 shows a representation of historical exchange rates between the two currencies of the relevant currency pair. For example, a horizontal axis of chart 420 indicates time, e.g., in hours, days, months, or years, whereas a vertical axis indicates the exchange rate of the currency pair at that time. A graph 421 indicates the exchange rate values that correspond to a historical time period. A user-movable pointer 422 is utilized to dynamically select a point in time, and the belt 410 is updated or refreshed to reflect the historical indicators at the selected time in the past.

In some embodiments, application 110 (FIG. 1) and/or tool 400 may analyze all the open currency trade positions of a specific currency pair, as well as their direction (e.g., Buy/Sell base currency), and may generate results using a current view and/or a historical view. In some embodiments, indicators 411-414 may be calculated as average values for substantially all the open currency trade positions of the specific currency pair; for example, the open rate indicator 411 reflects the average open rate; the stop loss indicator 413 reflects the average stop loss rate; and the take profit indicator 414 reflects the average take profit rate.

The data presented by tool 400 may be updated, re-calculated and/or refreshed, e.g., by application 110 (FIG. 1), for example, substantially continuously, substantially in real time, periodically, at pre-defined time intervals, e.g., every 15 seconds, in response to a user's command to refresh, and/or in response to incoming data indicating a change or a possible change in the presented data.

FIG. 5 schematically illustrates a block diagram of a visualization and trading tool 500 able to dynamically generate visual representation of an open position bar in accordance with some demonstrative embodiments. In one embodiment, tool 500 may perform the functionality of one of tools 112 (FIG. 1).

Tool 500 includes a textual portion 520 showing open position data, for example, deal reference number, amount of first currency to buy, amount of second currency to sell, open rate, current (or last) rate, stop loss rate, take profit rate, the current profit or loss, or the like.

A bar 510 organizes four data items in their relevant order: an open rate indicator 511, indicating the exchange rate at the opening of the trade on the current day; a current (or last) rate indicator 512, indicating the current exchange rate or “quote”; a stop loss indicator 513, indicating a maximum loss exchange rate as limited by the trader (in which the system is required to sell the currency and close the position); and a take profit indicator 514, indicating a maximum exchange rate as limited by the trader (in which the system is required to sell the currency and close the position).

Optionally, the area between the stop loss indicator 513 and the open rate indicator 511 is shown in a first color and/or pattern, e.g., red, to indicate a loss area; whereas the area between the open rate indicator 511 and the take profit indicator 514 is shown in a second color and/or pattern, e.g., green, to indicate a profit area.

The data presented by tool 500 may be updated, re-calculated and/or refreshed, e.g., by application 110 (FIG. 1), for example, substantially continuously, substantially in real time, periodically, at pre-defined time intervals, e.g., every 15 seconds, in response to a user's command to refresh, and/or in response to incoming data indicating a change or a possible change in the presented data. The data presented by tool 500 may further be updated, e.g., by application 110 (FIG. 1), in response to position modifications by the trader, for example, modification of the stop loss rate, modification of the take profit rate, or the like.

FIG. 6 schematically illustrates a block diagram of a visualization and trading tool 600 able to generate a dynamic trading gear in accordance with some demonstrative embodiments. In one embodiment, tool 600 may perform the functionality of one of tools 112 (FIG. 1).

In some embodiments, application 110 (FIG. 1) may receive, e.g., via input 185 (FIG. 1) and/or interface 111 (FIG. 1), a user input responsive to a user request for using tool 600 corresponding to a trade position of the user with relation to a financial asset. For example, interface 111 (FIG. 1) may provide the user with the option to use tool 600 with respect to a selected trading position, for example, from a set of currently opened trading positions of the user, e.g., in the form of a menu or list.

In some embodiments, tool 600 may include at least one graphical element, e.g., a gear 610 as described below, representing the trade position, and one or more user-controllable graphical indicators, e.g., buttons 615 and/or 616 as are described below, representing one or more respective position-related parameters of the trade position.

Tool 600 may be presented to the user in proximity to a textual portion showing open position data, for example, deal reference number, amount of first currency to buy, amount of second currency to sell, open rate, current (or last) rate, stop loss rate, take profit rate, the current profit or loss, or the like.

Trading gear 610 organizes four data items in their relevant order on a semi-circle: an open rate indicator 611, indicating the exchange rate at the opening of the trade on the current day; a current (or last) rate indicator 612, indicating the current exchange rate or “quote”; a stop loss indicator 613, indicating a maximum loss exchange rate as limited by the trader (in which the system is required to sell the currency and close the position); and a take profit indicator 614, indicating a maximum exchange rate as limited by the trader (in which the system is required to sell the currency and close the position).

Optionally, the area between the stop loss indicator 613 and the open rate indicator 611 is shown in a first color and/or pattern, e.g., red, to indicate a loss area; whereas the area between the open rate indicator 611 and the take profit indicator 614 is shown in a second color and/or pattern, e.g., green, to indicate a profit area.

The data presented by tool 600 may be updated, re-calculated and/or refreshed, e.g., by application 110 (FIG. 1) for example, substantially continuously, substantially in real time, periodically, at pre-defined time intervals, e.g., every 15 seconds, in response to a user's command to refresh, and/or in response to incoming data indicating a change or a possible change in the presented data. The data presented by tool 600 may further be updated in response to position modifications by the trader, for example, modification of the stop loss rate, modification of the take profit rate, e.g., as described below.

In some embodiments, trading application 110 (FIG. 1) may receive, e.g., via input 185 (FIG. 1) and/or interface 111 (FIG. 1), an input responsive to movement of at least one of the graphical indicators 615 and 616, e.g., by the user. Trading application 110 (FIG. 1) may dynamically update the trade position based on the input.

In some embodiments, trading application 110 (FIG. 1) may dynamically update the trade position by updating the trade-position-related parameters based on the input. In one embodiment, trading application 110 (FIG. 1) may provide an indication of the one or more updated trade-position-related parameters to transaction-processing system 123 (FIG. 1). For example, trading application 110 (FIG. 1) may send and/or transfer to transaction-processing system 123 (FIG. 1) one or more instructions and/or messages including and/or representing the updated trade-position-related parameters, and/or instructing transaction-processing system 123 (FIG. 1) to perform one or more operations, e.g., sell and/or buy operations, with relation to the trade position of the user, e.g., based on the updated trade-position-related parameters.

In some embodiments, the user may select, move or drag the stop loss indicator 613, for example, using a dragging button 615. For example, the user moves the stop loss indicator 613 to the right, thereby increasing the stop loss rate; accordingly, a new loss limit is dynamically calculated and is shown in box 621. In some embodiments, once the user releases the stop loss indicator 613, the position details are automatically modified to match the stop loss rate indicated by the stop loss indicator 613; optionally, the user may be required to select a “submit” button 623 in order to actually apply to his trading position the changes that he made using the gear.

Similarly, the user may select, move or drag the take profit indicator 614, for example, using a dragging button 616. For example, the user moves the take profit indicator 614 to the right, thereby increasing the take profit rate; accordingly, a new profit limit is dynamically calculated and is shown in box 622. In some embodiments, once the user releases the take profit indicator 614, the position details are automatically modified to match the take profit rate indicated by the take profit indicator 614; optionally, the user may be required to select a “submit” button 623 in order to actually apply to his trading position the changes that he made using the gear.

In some embodiments, tool 600 may be implemented using a dynamic gear having another shape, for example, a bar-shaped gear with one or more user-controllable indicators; a pie-chart having user-re-sizeable slices or dimensions; a graph having edges or points which may be moved or dragged by the user; or other shapes allowing the user to re-size a perimeter, dimensions, or characteristics. Other suitable mechanisms may be used to graphically or visually present stop loss data, take profit data, current rate data, and/or opening rate data. Other suitable mechanisms may be used to allow the user to dynamically and/or controllably modify the stop loss data, take profit data, current rate data, and/or opening rate data.

In some embodiments, a tool similar to tool 600 may be used to implement a calculator tool, allowing the user to simulate a hypothetic currency deal. For example, the user may enter the currency to sell, the currency to buy, the amount to trade, an exchange rate, and optionally a forward date. The calculator may calculate the profit or loss based on parameters that the user may modify. Optionally, graphical elements may be used to reflect a current rate indicator, an opening rate indicator, a stop loss indicator, and/or a take profit indicator may be shown in context of a bar, a gear, or the like. The user may drag or move one or more indicators, and numerical data may be re-calculated and updated based on the modified indicators, and may be shown in boxes in the calculator tool. Accordingly, movement of the indictor(s) in the dynamic gear or bar is translated into re-calculated profit or loss in the boxes showing numerical data.

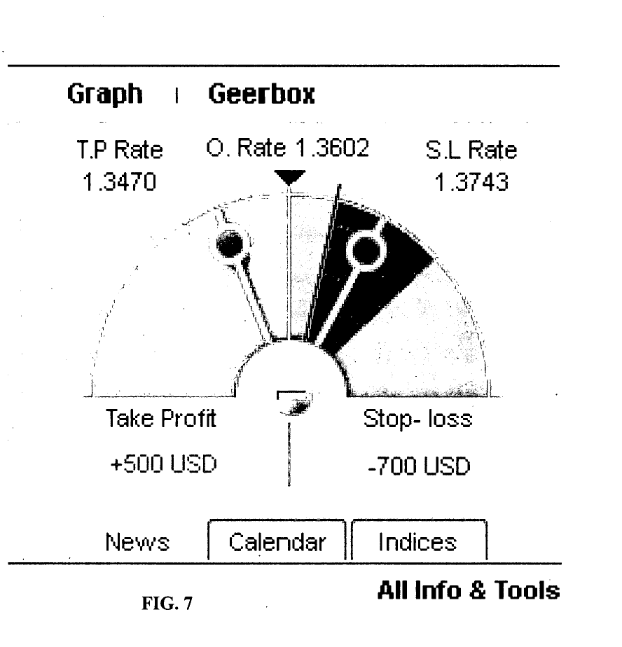

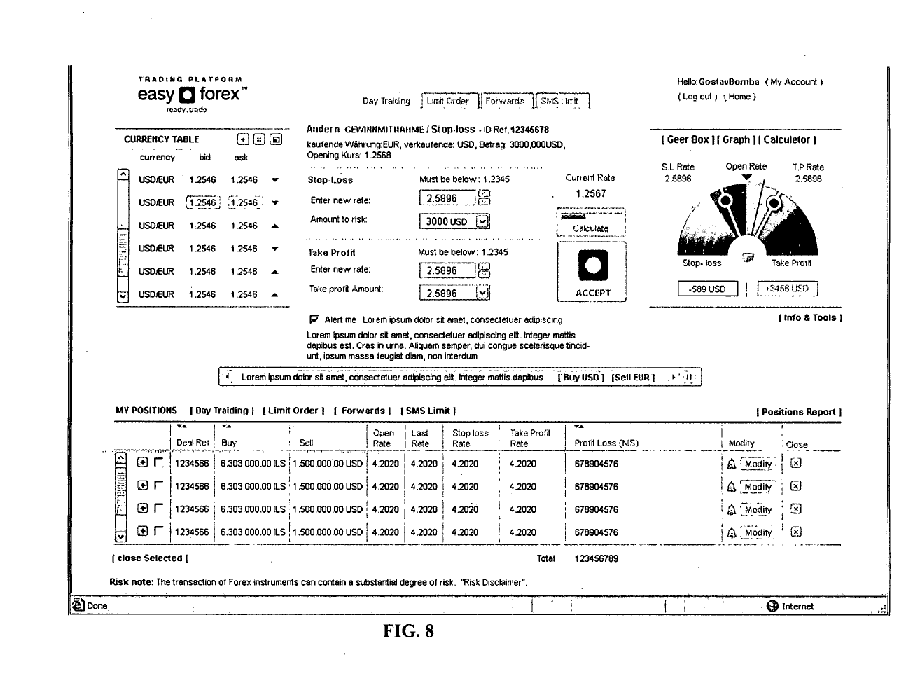

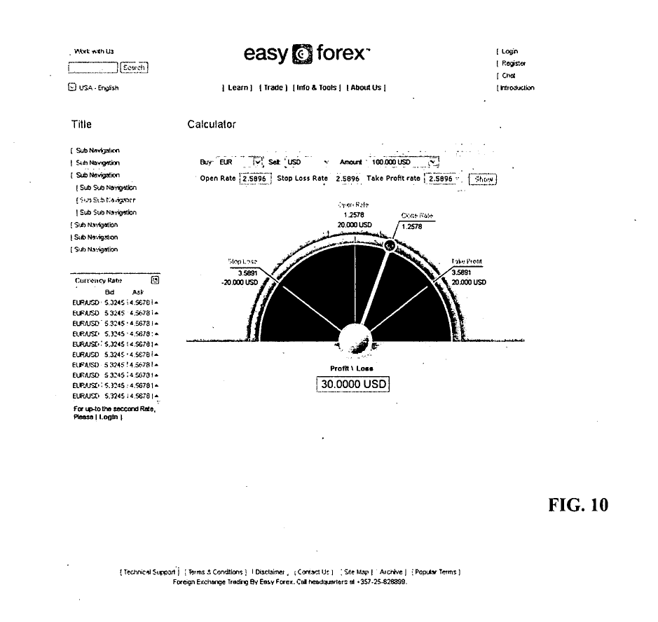

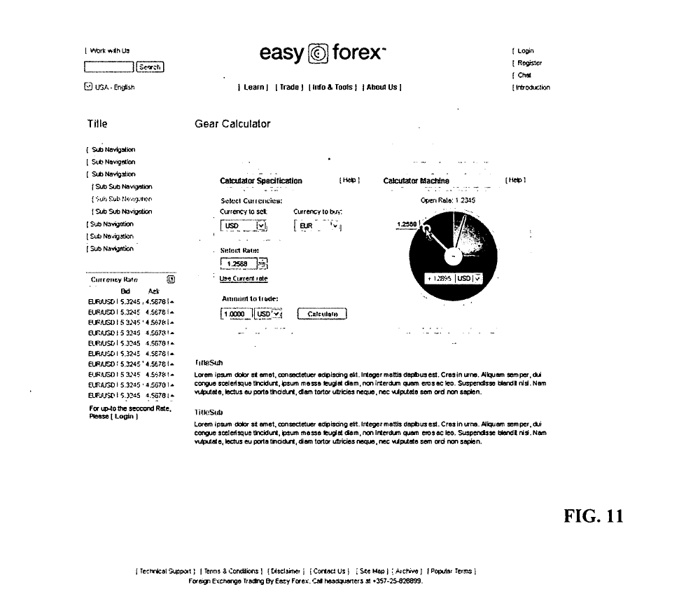

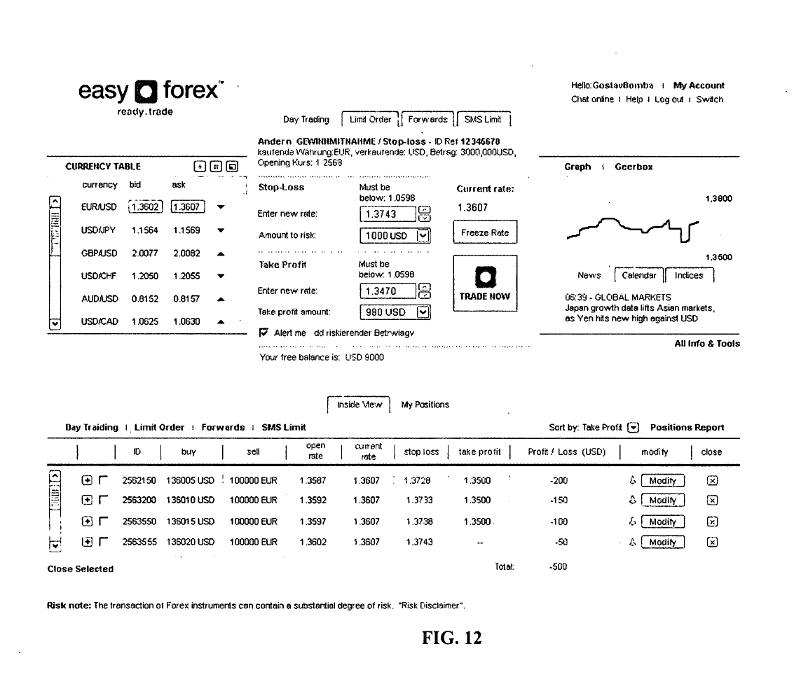

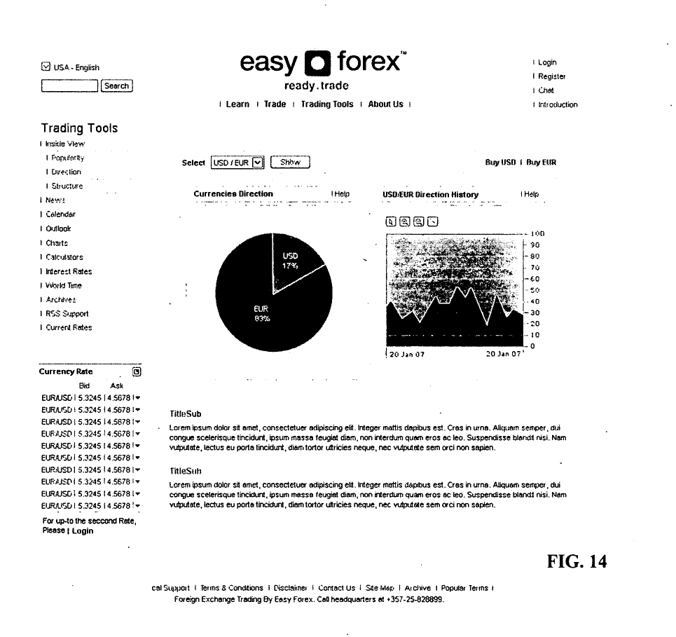

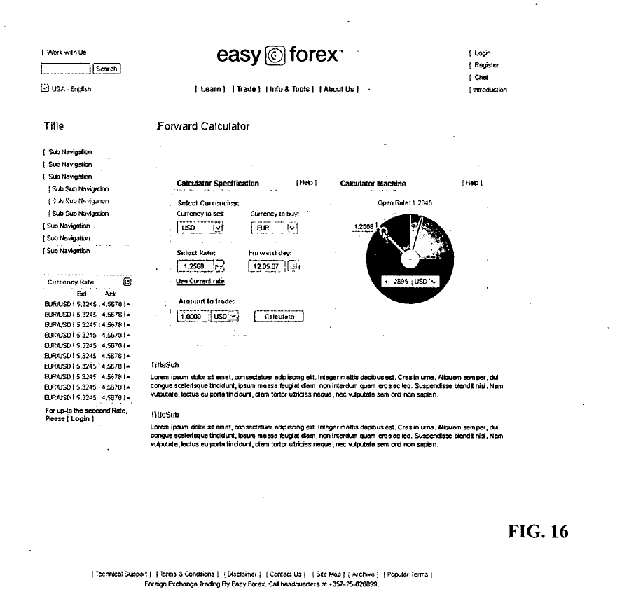

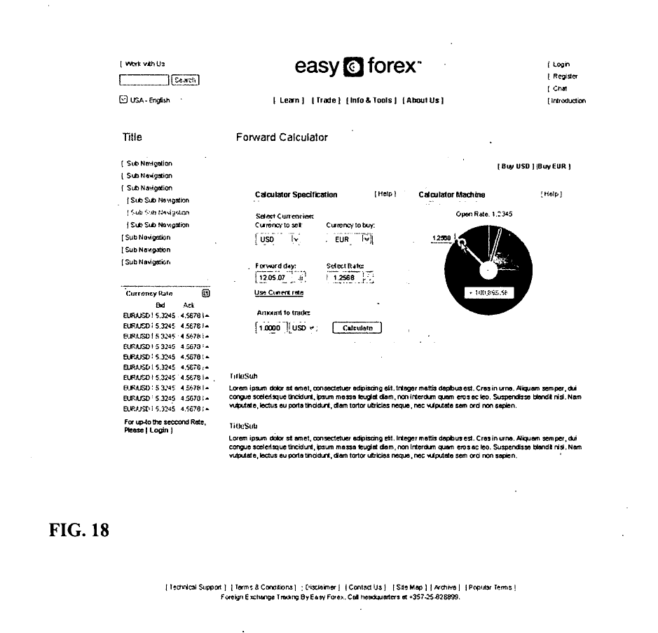

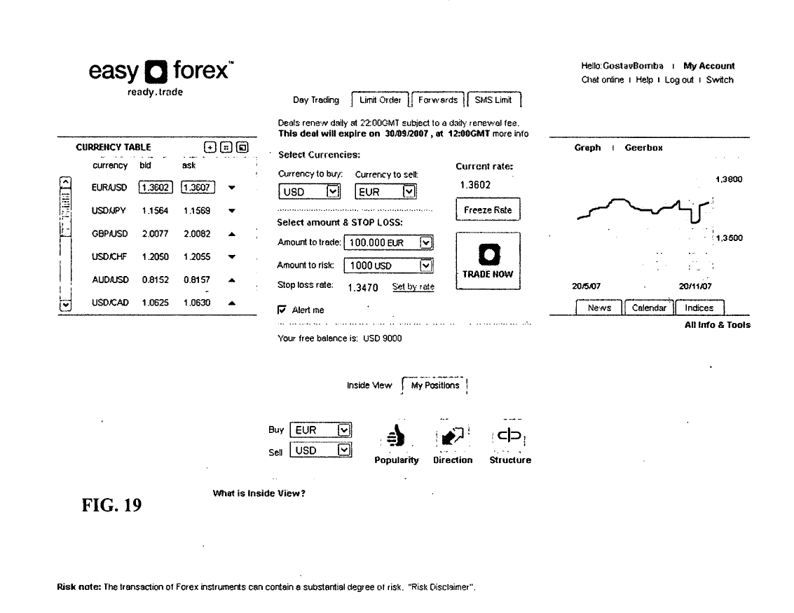

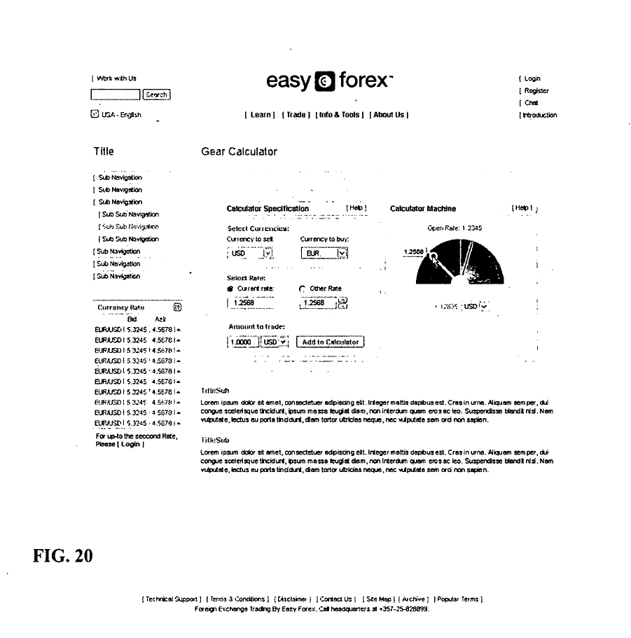

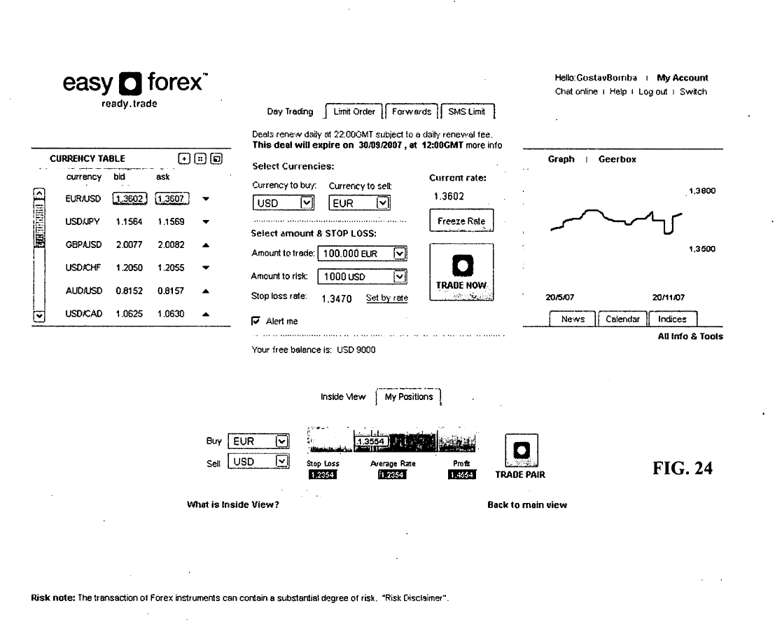

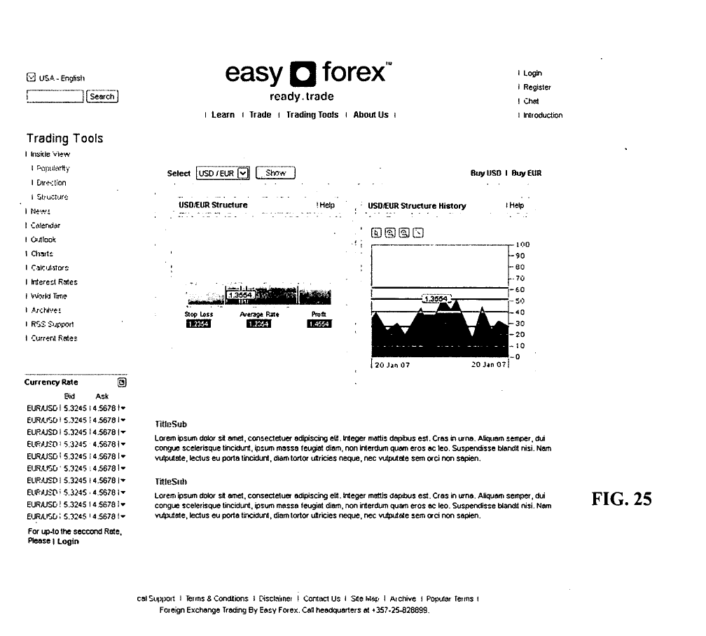

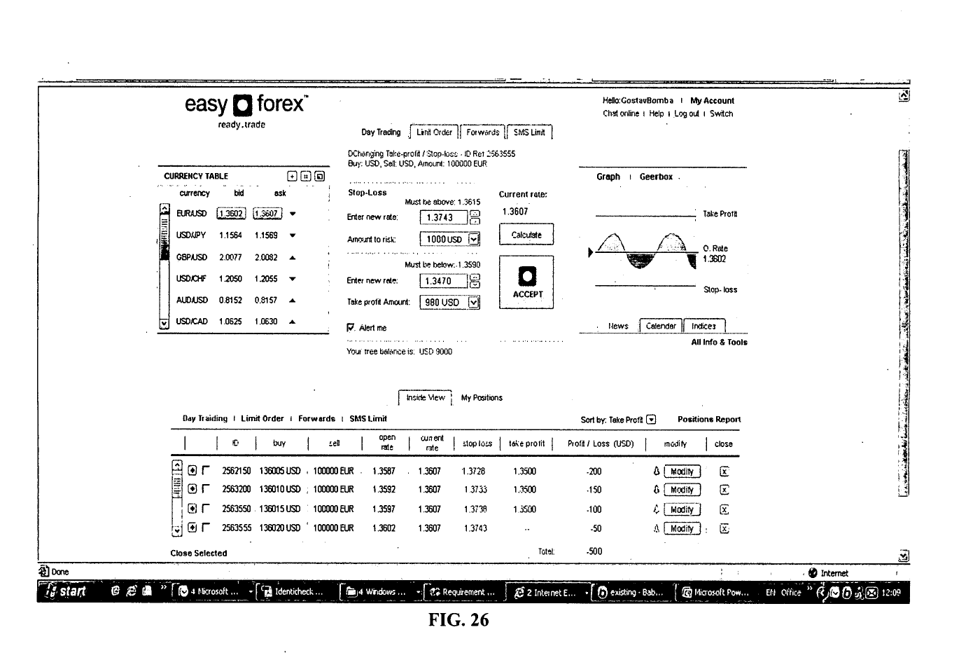

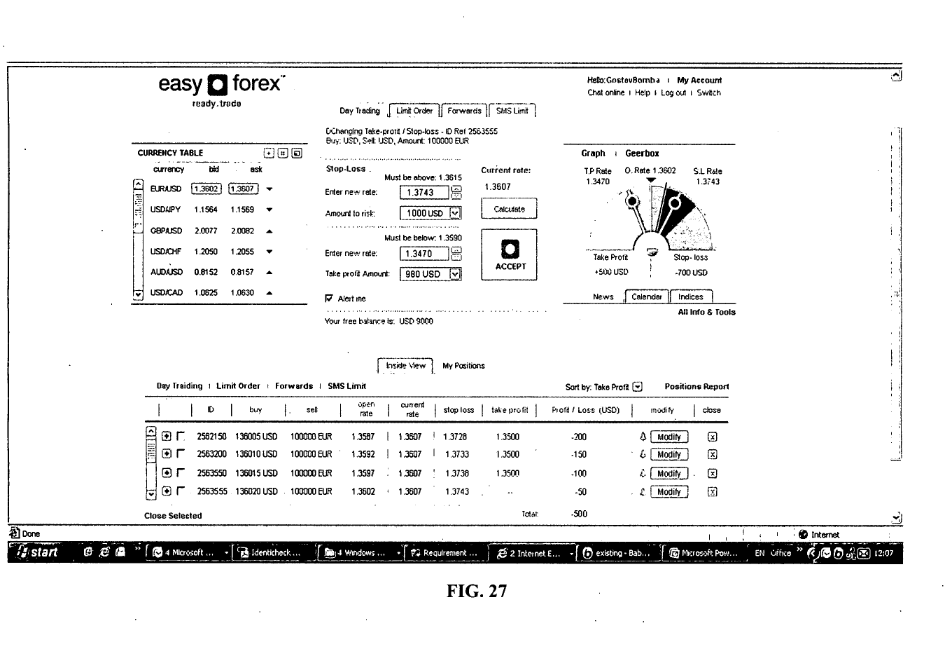

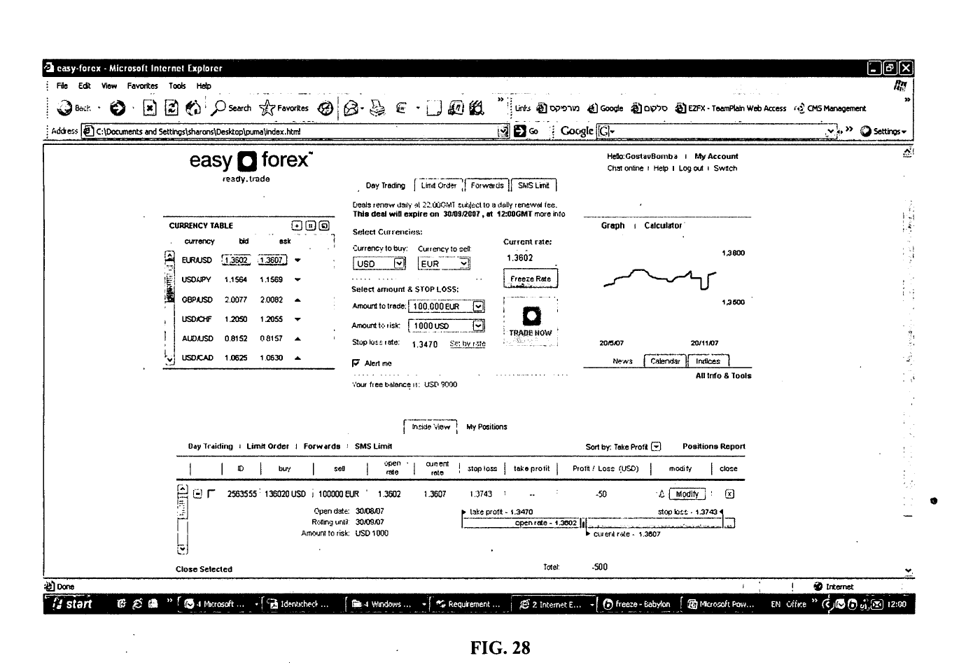

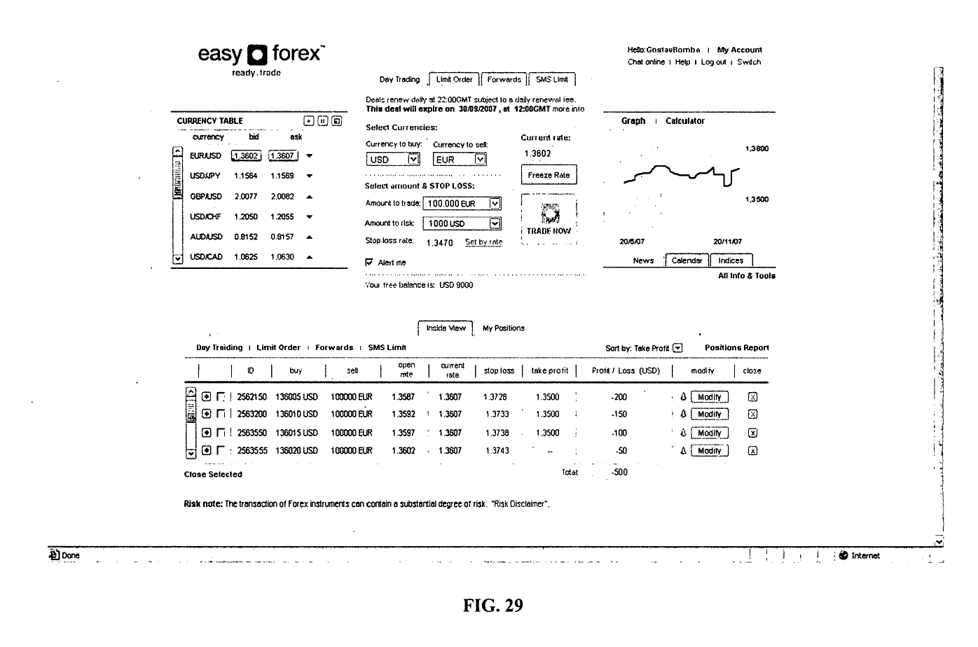

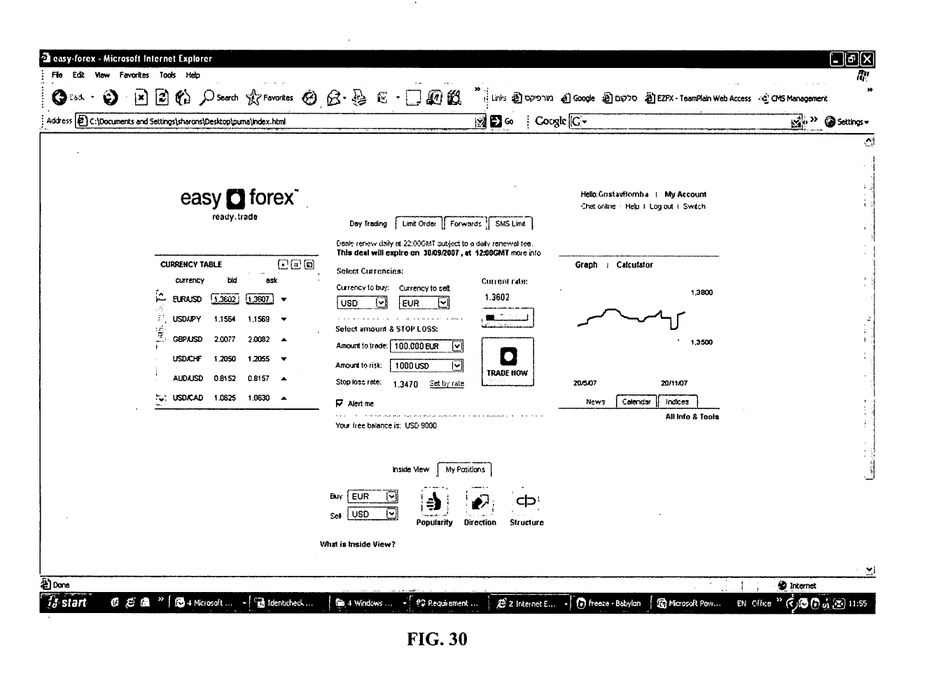

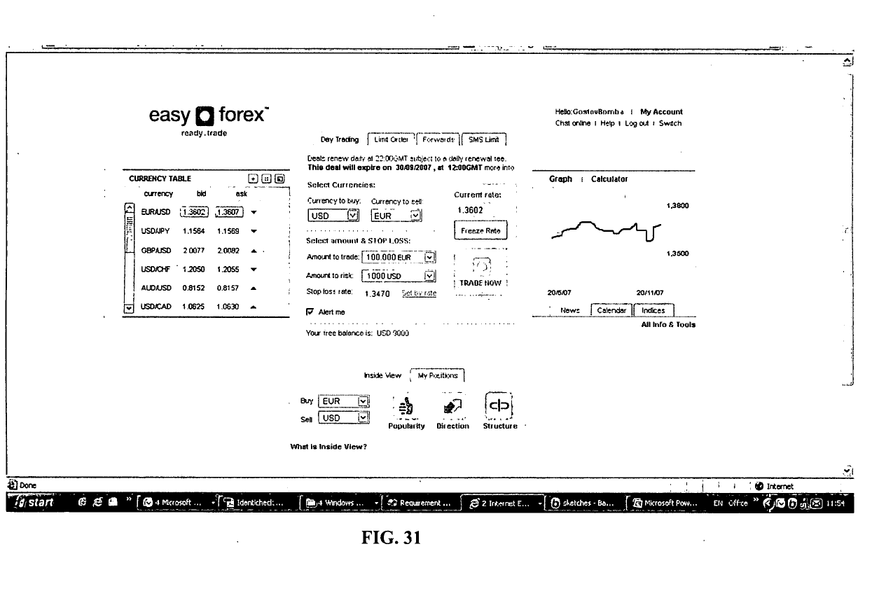

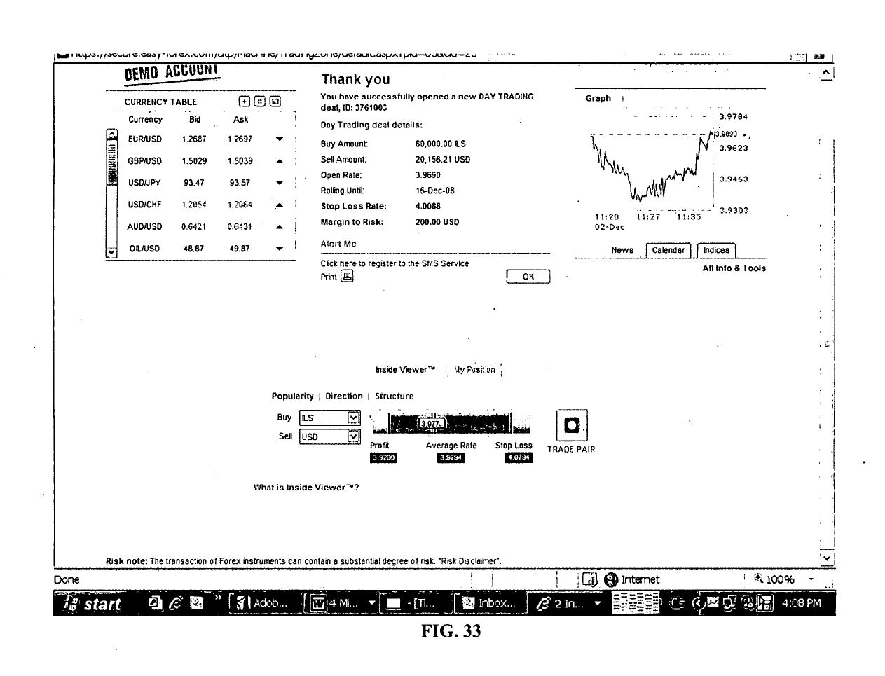

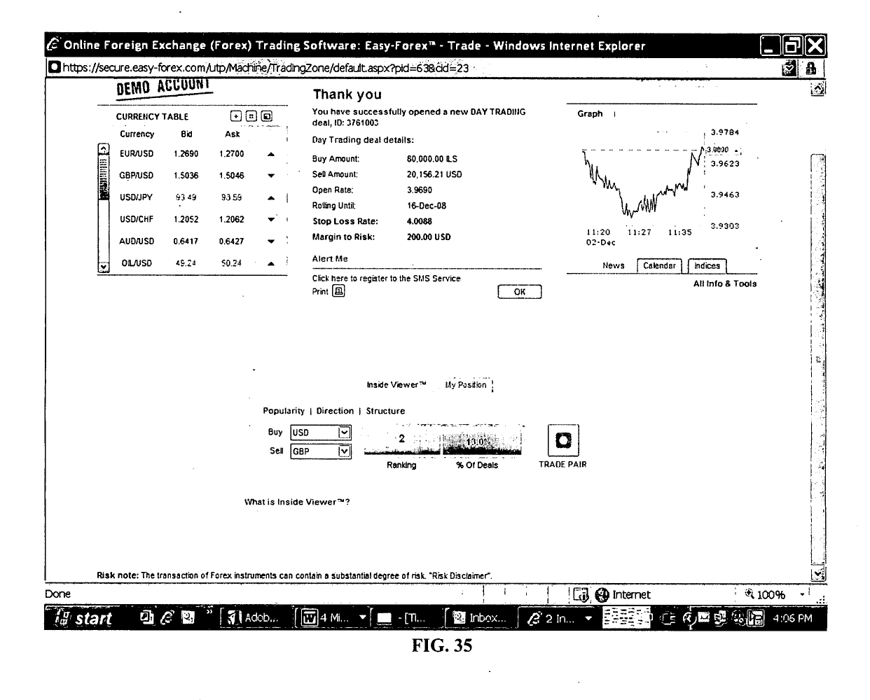

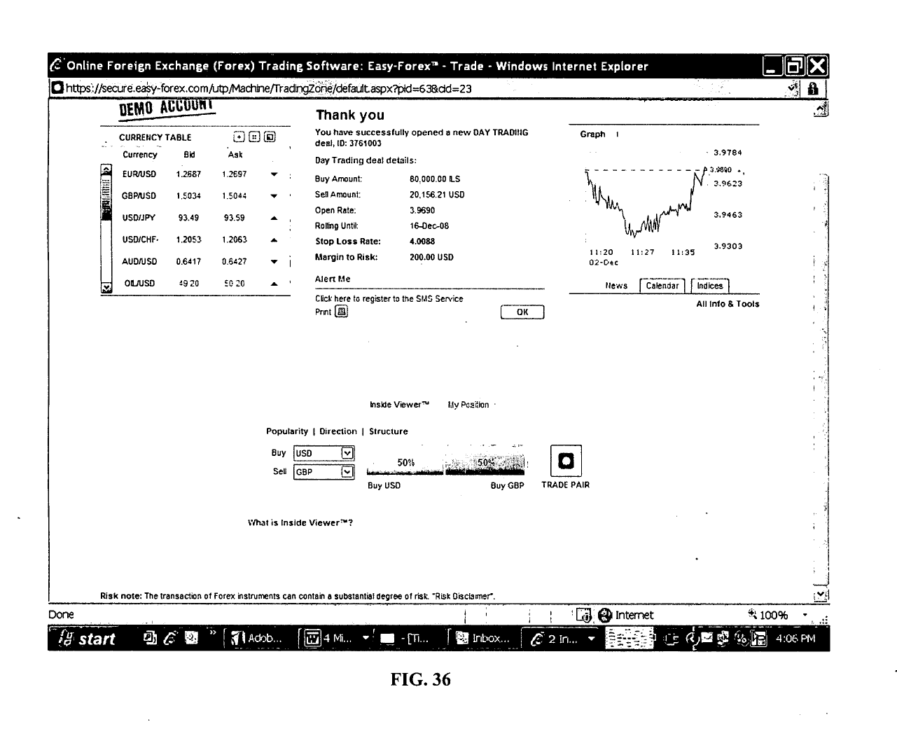

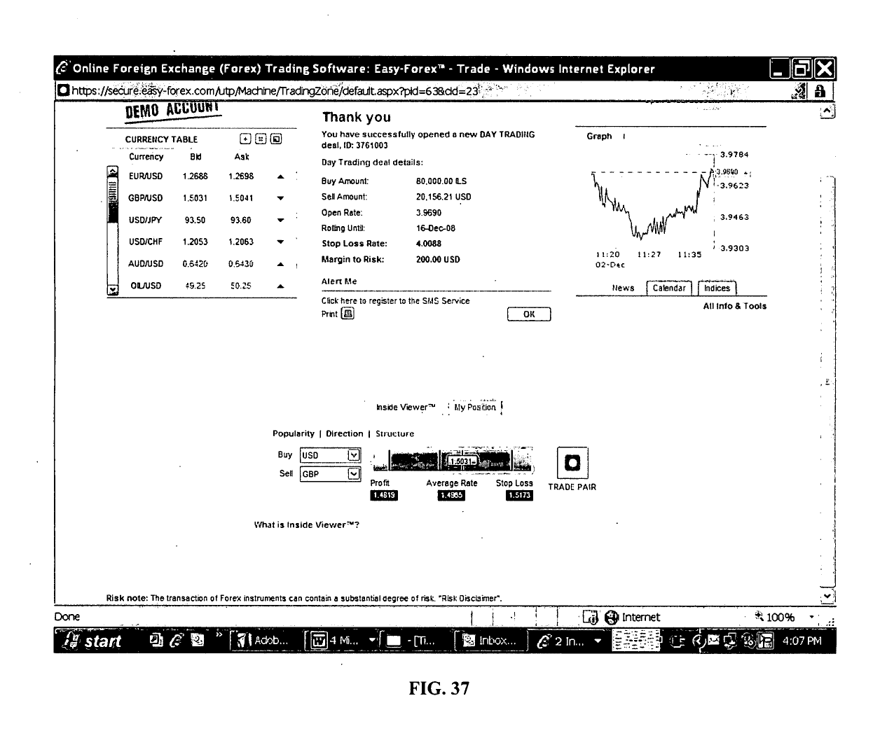

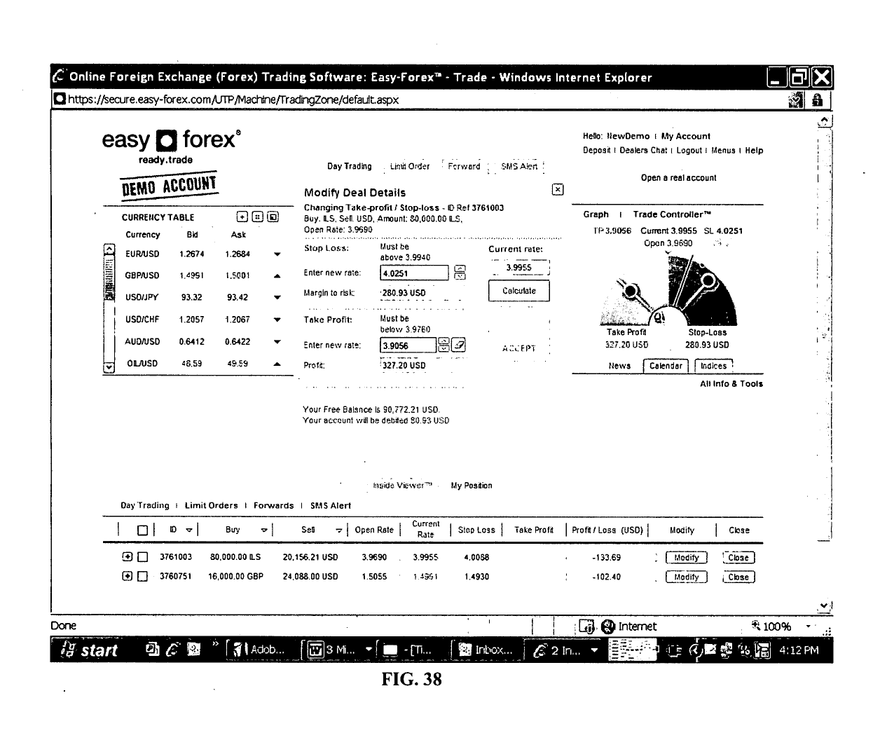

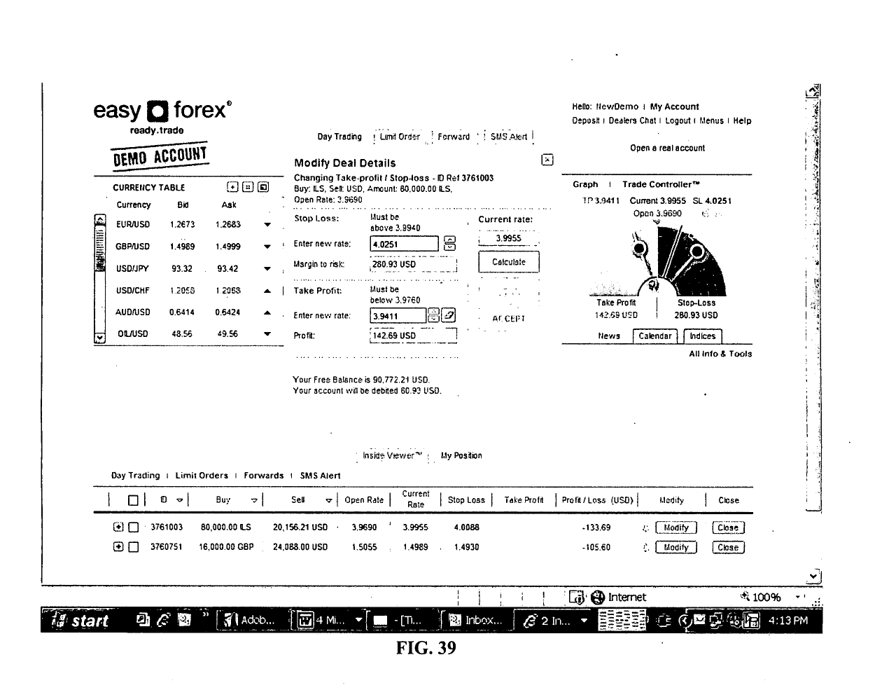

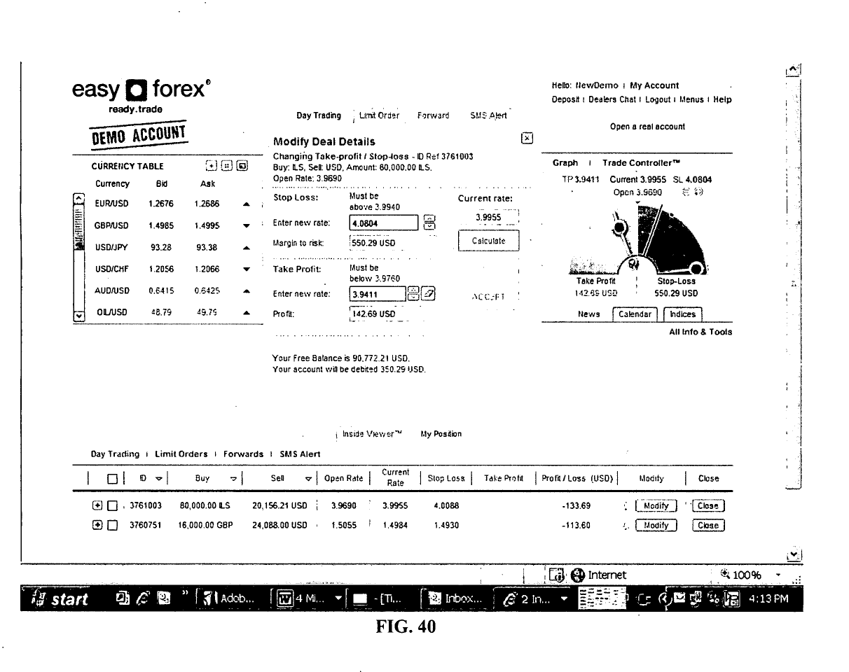

FIGS. 7-40 are schematic illustrations of interface components and trading tools in accordance with some demonstrative embodiments. For example, interface 11 (FIG. 1) may allow the user to select a currency-pair, amount, currency exchange rates, and/or other parameters (FIG. 26); to temporarily “freeze” or maintain a currency exchange rate (FIG. 27); to execute the transaction (FIG. 28); to view transaction details (FIG. 29); and/or to modify parameters of an existing day transaction (FIGS. 30-31).

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A system comprising:
a memory having stored thereon trading-application instructions; and
a processor to execute the trading-application instructions resulting in a trading application,
wherein the trading application is able to cause a display device to display to a user a visualized trading tool corresponding to a trade position of the user with relation to a financial instrument,
wherein the visualized trading tool includes at least one graphical element representing the trade position, and one or more user-controllable graphical indicators representing one or more respective position-related parameters of the trade position, and
wherein the trading application is able to receive an input responsive to movement of at least one of the graphical indicators and to dynamically update the trade position based on the input.

2. The system of claim 1, wherein the trading application is able to dynamically update the trade position by updating the trade-position-related parameters based on the input.

3. The system of claim 2, wherein the trading application is able to provide an indication of the one or more updated trade-position-related parameters to a transaction-processing system.

4. The system of claim 1, wherein the trading application is able to provide the user with at least one of a profit limit and a loss limit corresponding to the trade position, and to update the at least one of the profit and loss limits based on the movement of the graphical indicator by the user.

5. The system of claim 1, wherein the one or more position-related parameters include at least one of a stop-loss value and a take-profit value.

6. The system of claim 1, wherein the trading application is able to dynamically update the graphical element based on real-time data corresponding to one or more instrument-related parameters corresponding to the financial instrument.

7. The system of claim 6, wherein the instrument-related parameters include at least one of an open rate and a current rate of the financial asset.

8. The system of claim 1, wherein the one or more user-controllable graphical indicators include a stop-loss indicator indicating a stop-loss value defined by the user and a take-profit indicator indicating a take-profit value defined by the user, and
wherein the graphical element includes a graphical representation of a current value of the financial asset positioned between the stop-loss and take-profit indicators.

9. The system of claim 1, wherein the graphical element is a two-or-more dimensional graphical element.

10. The system of claim 1, wherein the financial asset includes a foreign-exchange asset corresponding to at least a pair of currencies.

11. The system of claim 1, wherein the at least one graphical element includes at least one of a gear, a semi-circular gear, a bar chart, and a belt chart.

12. A system comprising:
a memory having stored thereon trading-application instructions; and
a processor to execute the trading-application instructions resulting in a trading application,
wherein the trading application is able to receive a user input requesting aggregated trade-position data corresponding to at least one financial asset,
wherein trading application is able to receive from a database trade-position data of a plurality of trade positions of a plurality of other users with relation to the financial asset,
wherein the trading application is able to determine the aggregated trade-position data based on the plurality of trade positions, and
wherein the trading application is able to cause a display device to display to the user a visualized trading tool representing the aggregated trade-position data.

13. The system of claim 12, wherein the application is able to receive real-time trade-position data, to dynamically update the aggregated trade-position data based on the real-time trade-position data, and to dynamically update the visualized trading tool based on the updated aggregated trade-position data.

14. The system of claim 12, wherein at least one financial asset includes a plurality of financial assets,
wherein the visualized trading tool indicates one or more proportional relationship values corresponding to one or more of the plurality of financial assets,
wherein the application is able to determine a proportional relationship value of the one or more proportional relationship values corresponding to a financial asset of the plurality of financial assets based on a relationship between a volume-related value corresponding to the financial asset and volume-related values corresponding to other financial assets of the plurality of financial assets, and
wherein the application is able to cause the display device to display to the user the visualized trading tool indicating the one or more proportional relationship values.

15. The system of claim 14, wherein the proportional relationship value corresponding to the financial asset includes at least one of:
a ranking of the volume-related value corresponding to the financial asset relative to the volume-related values corresponding to the other financial assets, and
a ratio between the volume-related value corresponding to the financial asset and a total of the volume-related values corresponding to the plurality of financial assets.

16. The system of claim 14, wherein the volume-related value corresponding to the financial asset includes a number of trade positions corresponding to the financial asset.

17. The system of claim 14, wherein the plurality of financial assets include a plurality of currency pairs.

18. The system of claim 14, wherein the visualized trading tool includes a pi-chart, which includes a plurality of segments corresponding to the proportional relationship values, respectively.

19. The system of claim 12, wherein the visualized trading tool corresponds to a pair of first and second currencies,
wherein the application is able to receive trade-position data corresponding to the first and second currencies,
wherein the application is able to determine a first number of trade-positions relating to selling the first currency and buying the second currency and a second number of trade-positions relating to selling the second currency and buying the first currency,
wherein the application is able to determine a proportional relationship between the first and second numbers, and
wherein the application is able to cause the display device to display to the user visualized trading tool visualizing the proportional relationship between the first and second numbers.

20. The system of claim 19, wherein the visualized trading tool includes a visualized representation of a plurality of previous proportional relationships between the first and second numbers.

21. The system of claim 12, wherein the application is able to receive at least a plurality of stop-loss values of the plurality of trade-positions, respectively, and a plurality of take-profit values of the plurality of trade-positions, respectively,
wherein the application is able to determine an average stop-loss value based on the plurality of stop-loss values, and an average take-profit value based on the plurality of take-profit values, and
wherein the application is able to cause the display device to display to the user the visualized trading tool visualizing a relationship between the average stop-loss value, the average take-profit value and a current value of the financial asset.

22. The system of claim 21, wherein the visualized trading tool includes a visualized representation of a plurality of previous values of the financial asset,
wherein the application is able to receive an input responsive to a user selected previous value of the financial asset, and
wherein the application is able to update the visualized trading tool to visualize a relationship between previous average stop-loss and average tale-profit values corresponding to the selected previous value of the financial asset.
